(19) United States
(12) Patent Application Publication
(10) Pub. No.: US 2026/0079030 A1
(43) Pub. Date: Mar. 19, 2026

(54) MAGNETOINDUCTIVE REFLECTOMETRY

(71) Applicant: Oxford University Innovation Limited, Oxford (GB)

(72) Inventors: Daffodil DHAYAA, Oxford (GB); Anna RADKOVSKAYA, Oxford (GB); Laszio SOLYMAR, Oxford (GB); Ekaterina SHAMONINA, Oxford (GB); Callum Patrick LONG, Oxford (GB)

(21) Appl. No.: 19/109,148

(22) PCT Filed: Aug. 24, 2023
(86) PCT No.: PCT/GB2023/052200

§ 371 Date: Mar. 6, 2025

(30) Foreign Application Priority Data
Sep. 9, 2022 (GB) 2213194.0

(51) Int. Cl. G01D 5/20

(52) U.S. Cl. CPC G01D 5/204

(57) ABSTRACT

A location of conductive material in the vicinity of a magnetoinductive waveguide comprising an array of magnetically coupled resonant circuit elements is determined by analysing a reception signal detected from a reception resonant circuit element of the array. An echo signal is detected in the reception signal, the echo signal corresponding to reflected magnetoinductive waves i by reflection of injected magnetoinductive waves at an impedance discontinuity created by conductive material in the vicinity of a resonant circuit element. A timing of the echo signal is determined and the location of the resonant circuit element at which the impedance discontinuity is created is determined from the timing, as the location of the conductive material.

The present invention relates to magnetoinductive reflectometry to determine a location of conductive material in the vicinity of a magnetoinductive waveguide.

A magnetoinductive waveguide comprising an array of magnetically coupled resonant circuit elements is an example of a metamaterial and supports the propagation of a magnetoinductive wave. The propagation of a magnetoinductive wave along an array of magnetically coupled split-ring resonators occurs on account of magnetic coupling between the resonant circuit elements and was first reported in References [1, 2].

In principle, magnetoinductive reflectometry using a magnetoinductive waveguide provides the opportunity to determine a location of conductive material. This is because conductive material in the vicinity of a resonant circuit element creates an impedance discontinuity that reflects the magnetoinductive wave, so the timing of an echo signal corresponding reflected magnetoinductive waves generated by such reflection corresponds to the location relative to the magnetoinductive waveguide. However, the study of metamaterials is in relatively early stage, and the practical implementation of magnetoinductive reflectometry remains a difficult technical problem.

Some of the principles of magnetoinductive reflectometry are discussed in Reference [3], which discloses a study of a magnetoinductive waveguide comprising an array of magnetically coupled resonant circuit elements including capacitively loaded inductors in the form of coils in a planar configuration. Frequency-domain reflectometry is performed for the purpose of detecting the location of a single defect formed by a conductive object in the form of a metal bolt in the vicinity of a resonant circuit element. This demonstrates an example of magnetoinductive reflectometry in the frequency domain, but the accuracy is limited by the ability to distinguish closely aligned peaks in the frequency domain.

Accordingly, it would be desirable to perform magnetoinductive reflectometry to determine a location of conductive material in the vicinity of a magnetoinductive waveguide in a practical manner.

According to a first aspect of the invention, there is provided a method of determining a location of conductive material in the vicinity of a magnetoinductive waveguide comprising an array of resonant circuit elements that are magnetically coupled together by analysing a reception signal detected from a reception resonant circuit element of the array, the method comprising: detecting an echo signal within the reception signal, the echo signal corresponding to reflected magnetoinductive waves generated by reflection of injected magnetoinductive waves, injected by excitation of the magnetoinductive waveguide with an input signal in the form of a pulse, at an impedance discontinuity created by conductive material in the vicinity of a resonant circuit element; determining a timing of the detected echo signal; determining the location of the resonant circuit element at which the impedance discontinuity is created from the determined timing, as the location of the conductive material.

The present method provides a practical implementation for determining the location of conductive material in the vicinity of a magnetoinductive waveguide using magnetoinductive reflectometry.

Preferably, the method may comprise adjusting the reception signal by subtracting an unperturbed signal, the unperturbed signal corresponding to a reception signal which would be detected from the reception resonant circuit element in the absence of conductive material in the vicinity of the resonant circuit elements of the array, the step of detecting the echo signal comprises detecting the echo signal from the adjusted reception signal.

Such adjustment of the reception signal by subtracting an unperturbed signal improves the accuracy of the determination of location, because it reduces obscuration of the echo signal by the unperturbed signal, which is intrinsically superimposed in the reception signal. In practice, this has been found to improve the detection of the echo signal, allowing the location to be more accurately determined.

Preferably, the method may comprise determining plural locations of conductive material in the vicinity of the magnetoinductive waveguide, the step of detecting an echo signal comprises: detecting plural echo signals in the reception signal in turn, the plural echo signals corresponding to reflected magnetoinductive waves generated by reflection of the injected magnetoinductive waves at impedance discontinuities created by conductive material in the vicinity of respective resonant circuit elements; and between the detection of each successive one of the echo signals, modifying the sensed signal by subtraction of the previously detected echo signal from the reception signal, and the steps of determining a timing and determining the location of the resonant circuit element at which the impedance discontinuity is created are performed in respect of each detected echo signal.

Such a method provides an iterative approach to detection of plural echo signals generated by impedance discontinuities that are created by conductive material in the vicinity of different resonant circuit elements. The iterative modification of the reception signal by subtracting successive echo signals improves the accuracy of the determination of location, because it reduces the obscuration of echo signals by each other, given that the echo signals from possibly plural impedance discontinuities are superimposed in the reception signal. In practice, this has been found to improve the detection of plural echo signals, allowing them to be distinguished and the locations of plural impedance discontinuities to be more accurately determined.

Preferably, the method may comprise filtering the reception signal prior to the step of detecting an echo signal within the reception signal.

Such filtering has been found to improve the shape and detection of the echo signal, allowing timing and hence location to be more accurately determined.

Advantageously, the filtering may comprise bandpass filtering the reception signal with a passband corresponding to limits of passband behaviour in a magnetoinductive waveguide.

On the basis that a magnetoinductive waveguide exhibits passband behaviour, it has been appreciated that bandpass filtering the reception signal with a corresponding passband is an effective way to remove external noises and isolate the magnetoinductive waves. In practice, this has been found to improve the detection of the echo signal, allowing the location to be more accurately determined.

The limits may be derived from a dispersion relation derived for the magnetoinductive waveguide.

Alternatively or additionally, the filtering may comprise envelope smoothing of the sensed signal.

In practice, this has been found to improve the shape and detection of the echo signal, allowing timing and hence the location to be more accurately determined.

Preferably, the step of determining the location of the resonant circuit element at which the impedance discontinuity is created may be performed by comparing the determined timing with timing reference data that relates timing to location.

This allows the location to be determined without the need to estimate the group velocity of magnetoinductive waves propagating along the magnetoinductive waveguide on the basis of signals detected from the waveguide. The reference data may be derived from a theoretical analysis of the magnetoinductive waveguide. In practice, this has been found to improve the detection of the echo signal, allowing the location to be more accurately determined.

The step of detecting an echo signal within the reception signal may comprise detecting a peak in the reception signal corresponding to the reception signal.30

Advantageously, the method may further comprise: determining echo signal characteristics of a detected echo signal, and determining material characteristics of the conductive material, to which the detected echo signal corresponds, from the determined echo signal characteristics.

In this manner, characteristics of a detected echo signal may be used to derive material characteristics of the conductive material to which the detected echo signal corresponds. This allows additional information from the location to be derived.

The step of determining material characteristics may be performed by comparing the determined echo signal characteristics with characteristic reference data that relates the echo signal characteristics to the material characteristics.

The echo signal characteristics may include at least one of amplitude and phase.

This allows a wide range of material characteristics to be derived. Some non limitative examples include: a conductivity of the conductive material; a geometrical characteristic of the conductive material; a distance of the conductive material from the resonant circuit element in the vicinity of which it is located; and a lateral position of the conductive material in the direction of propagation of the injected magnetoinductive waves with respect to the resonant circuit element at which the impedance discontinuity is created.

According to further aspects of the present invention, there is provided a computer program capable of execution by a computer apparatus and configured, on execution, to cause the computer apparatus to perform a method according to the first aspect, a computer-readable storage medium storing such a computer program, and a computer apparatus configured to perform a method according to the first aspect.

According to further aspects of the present invention, the method may further comprise: exciting the magnetoinductive waveguide with the input signal in the form of a pulse; and detecting the reception signal from the reception resonant circuit element of the array.

Advantageously, the step of detecting the reception signal may be performed by a reception antenna that is spaced from the reception resonant circuit element.

This allows the reception signal to be detected in a manner that reduces the impact of the detection on the magnetoinductive waves along the magnetoinductive waveguide. In practice, this has been found to improve the detection of the echo signal, allowing the location to be more accurately determined.

Advantageously, the reception antenna may be spaced from the reception resonant circuit element by a spacing at which coupling between the reception antenna and resonant circuit elements adjacent to the receiver resonant circuit element is minimised.

This further allows the reception signal to be detected in a manner that reduces the impact of the detection on the magnetoinductive waves along the magnetoinductive waveguide. In practice, this has been found to improve the detection of the echo signal, allowing the location to be more accurately determined.

Advantageously, the array may comprise at least one idle resonant circuit element at a far end of the magnetoinductive waveguide from an input end where the magnetoinductive waveguide is excited, wherein at least one idle resonant circuit element has no conductive material in the vicinity thereof.

This allows the reception signal to be detected in a manner that reduces the impact of magnetoinductive waves reflected from the far end of the magnetoinductive waveguide, as the corresponding signal superimposed in the detection signal is separated from the echo signal of interest. In practice, this has been found to improve the detection of the echo signal, allowing the location to be more accurately determined.

The at least one idle resonant circuit element may comprise a number of idle resonant circuit elements that is sufficient to prevent reflection of the injected magnetoinductive waves at the termination of the magnetoinductive waveguide at the far end from obscuring echo signals corresponding to the impedance discontinuity created by conductive material in the vicinity of a resonant circuit element.

Advantageously, the input signal may excite at least one feeding resonant circuit element located before the reception resonant circuit element in the direction of propagation of the injected magnetoinductive waves.

This allows the reception signal to be detected in a manner that reduces the impact of the excitation on the echo signal. In practice, this has been found to improve the detection of the echo signal, allowing the location to be more accurately determined.

Embodiments of the invention will now be described, by way of non-limitative example, with reference to the accompanying drawings in which:

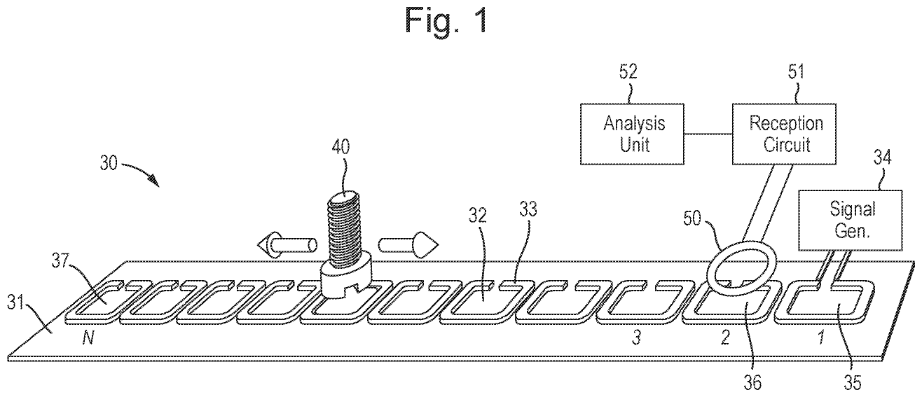

FIG. 1 is a perspective view of a magnetoinductive waveguide comprising an array of resonant circuit elements in the presence of a conductive material;

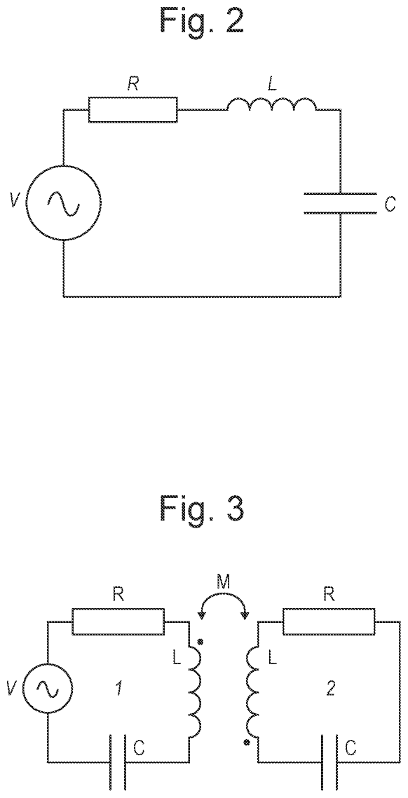

FIG. 2 is a circuit diagram of a resonant circuit element represented as an LCR circuit;

FIG. 3 is a circuit diagram of two coupled resonant circuit elements represented as identical LCR circuits;

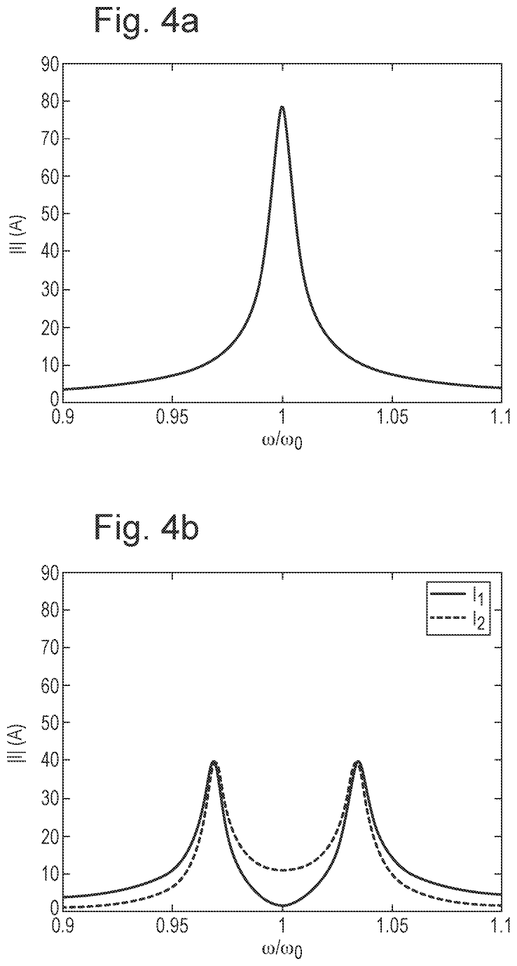

FIGS. 4a and 4b are graphs of a resonance curve for a single resonant circuit element and a pair of coupled resonant circuit elements, respectively, using parameters: split-ring side length d 10.5 mm, f₀=108.8 MHz, Q=107.4, coupling coefficient κ=−0.13, inductance L=20 nH and excitation voltage V=10 Vpp;

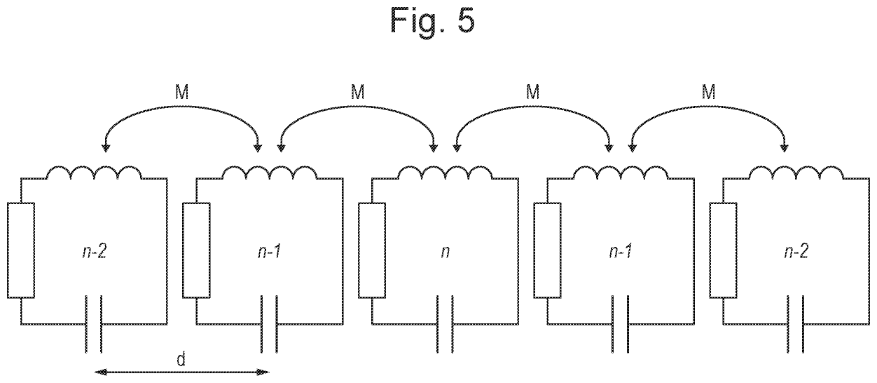

FIG. 5 is a circuit diagram of a section of the magnetoinductive waveguide represented as an array of LCR circuits with nearest neighbour coupling;

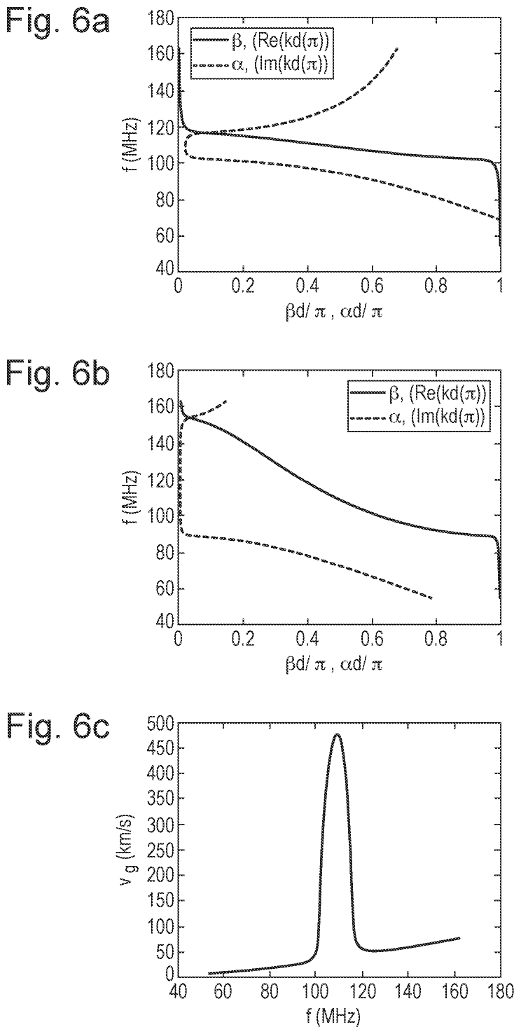

FIGS. 6a and 6b are graphs of dispersion relations for the magnetoinductive waveguide with coupling coefficients κ of value −0.13 and −0.5, respectively, for nearest neighbour coupling, and FIG. 6c is a graph of the velocity of each frequency component of the magnetoinductive waves for the case of κ=−0.13;

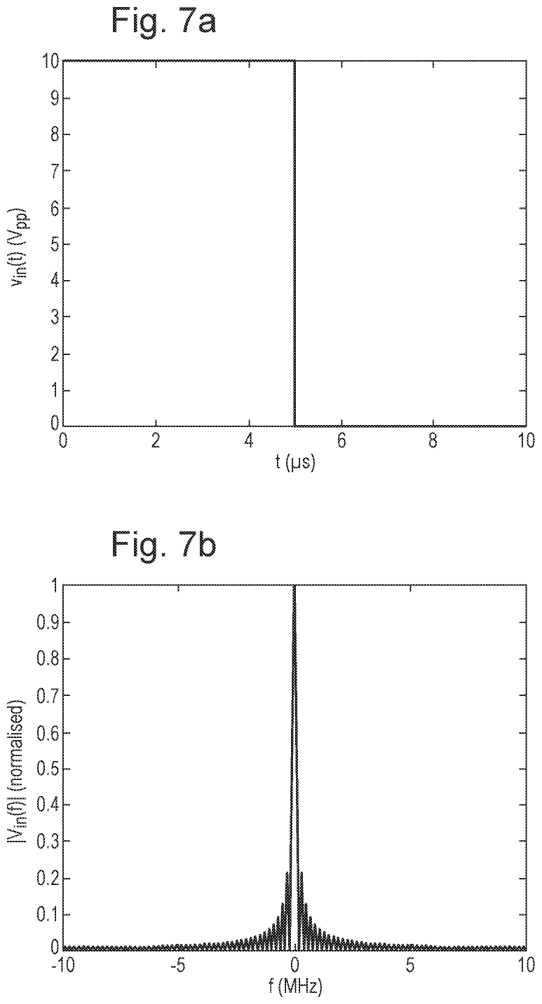

FIGS. 7a and 7b are graphs of a square pulse in the time domain and the frequency domain respectively, using parameters: excitation voltage V=10 Vpp, f=100 kHz and duty cycle=50%;

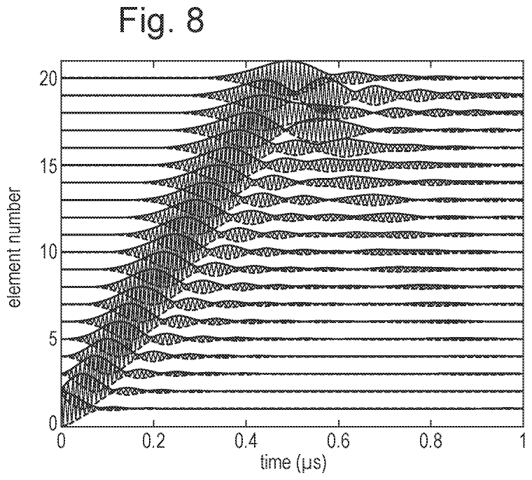

FIG. 8 is a set of graphs of analytical results showing the signal at each resonant circuit element for a magnetoinductive wave travelling through the magnetoinductive waveguide, without impedance discontinuities, using the same parameters as FIGS. 4a and 4b;

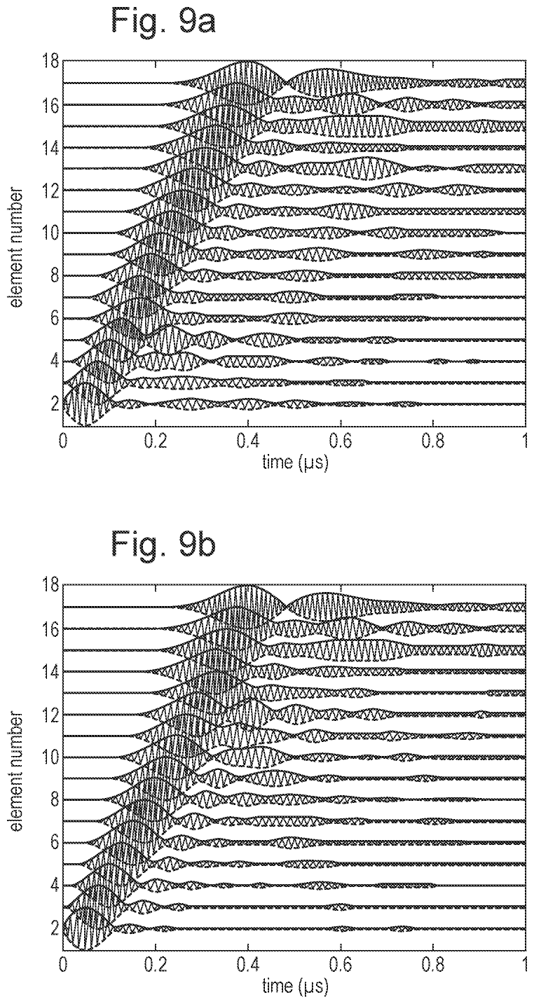

FIGS. 9a and 9b are a pair of graphs of analytical results showing the signal at each resonant circuit element for a magnetoinductive wave travelling through the magnetoinductive waveguide, with single impedance discontinuities at resonant circuit element nos. 7 and 14, respectively, using the same parameters as FIGS. 4a and 4b;

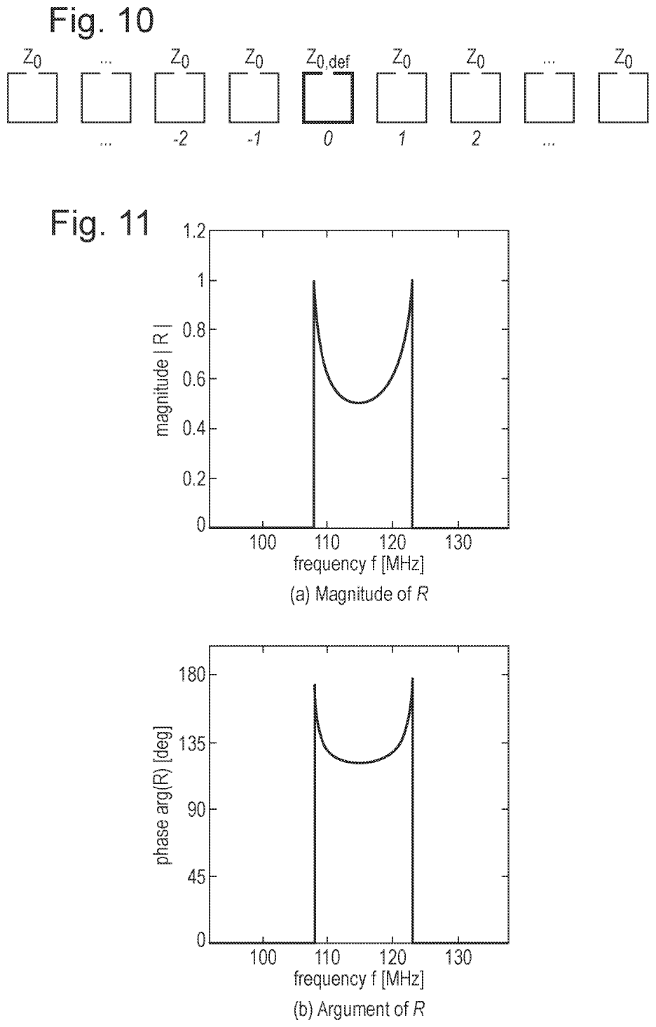

FIG. 10 is a schematic diagram of a magnetoinductive waveguide comprising an array of resonant circuit elements in the presence of a conductive material adjacent the resonant circuit element numbered 0;

FIG. 11 is a pair of graphs of the frequency response of (a) the magnitude of reflection coefficient R and (b) the phase of reflection coefficient R in a theoretical model of a magnetoinductive waveguide;

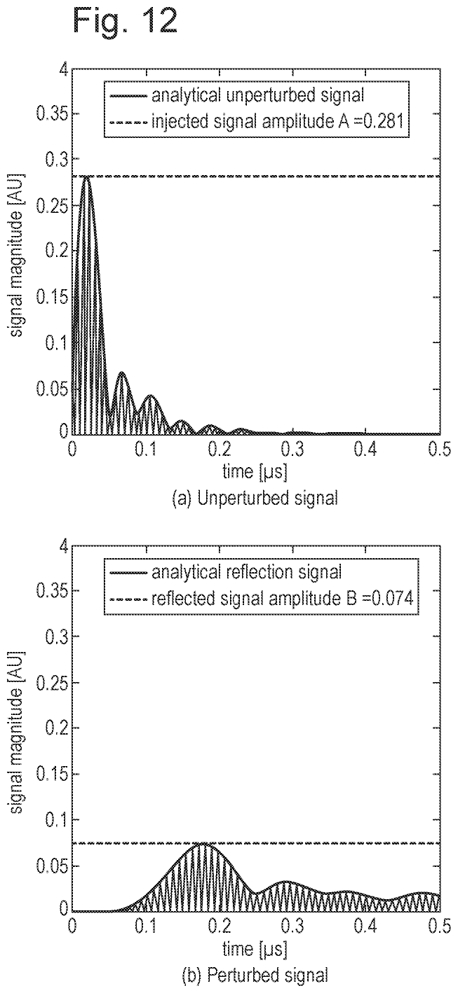

FIG. 12 is a pair of graphs of analytically derived reception signals and their upper envelopes for (a) an unperturbed reception signal derived from injected magnetoinductive waves alone, and (b) an echo signal for a conductive object with no spacing from a particular resonant circuit element;

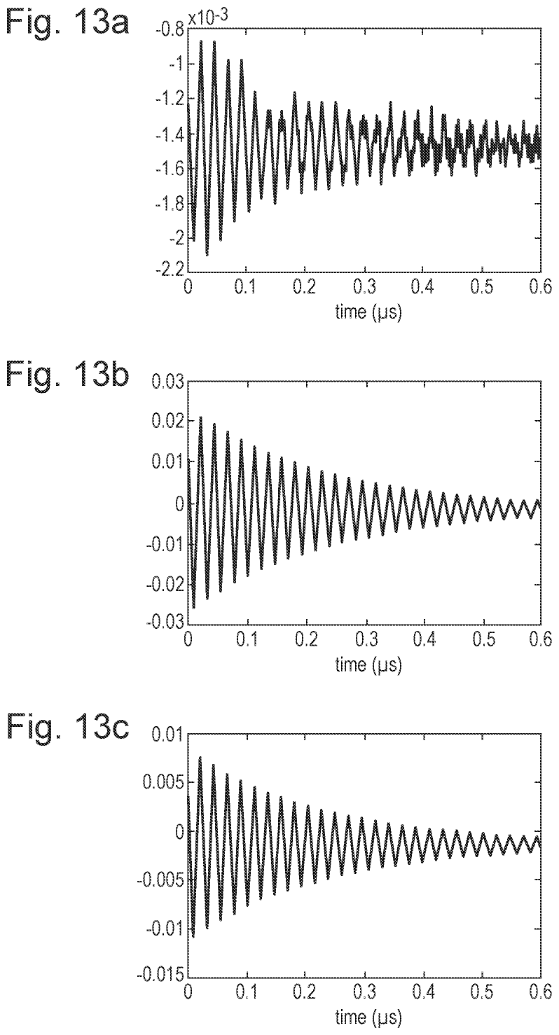

FIGS. 13a to 13c are graphs of the reception signal over time detected in the sensing antenna when positioned at the ideal spacing from the split-ring of a single sensing resonant element in the axial direction and at lateral positions of one, two and three split-ring side lengths, respectively, the signals being normalised to the maximum signal detected when the antenna is positioned directly above the single split-ring element;

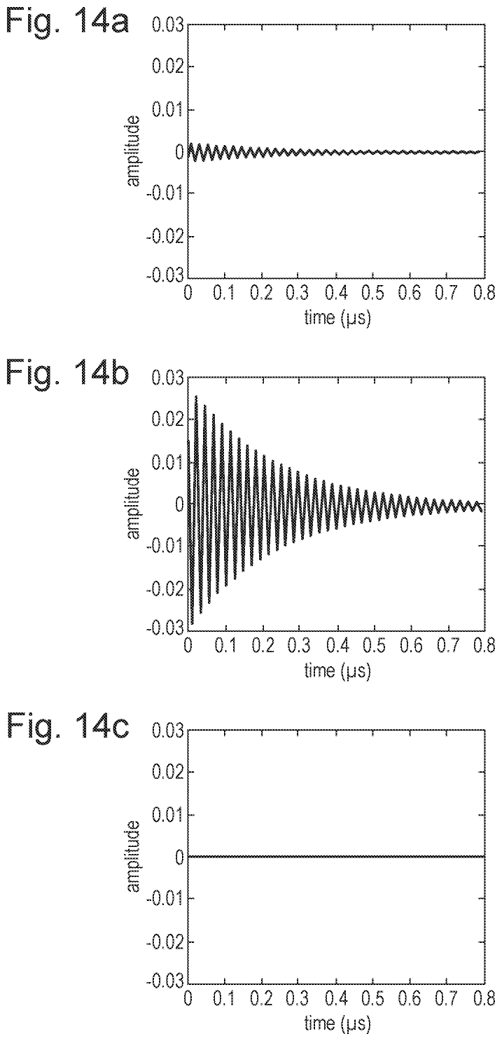

FIGS. 14a to 14c are graphs of the reception signal over time detected in the sensing antenna when positioned at spacings from the split-ring of the sensing resonant element of 2 mm more than the ideal spacing, 2 mm less than the ideal spacing, and the ideal spacing, respectively, where the ideal spacing is such that the signal detected from neighbouring elements is minimised;

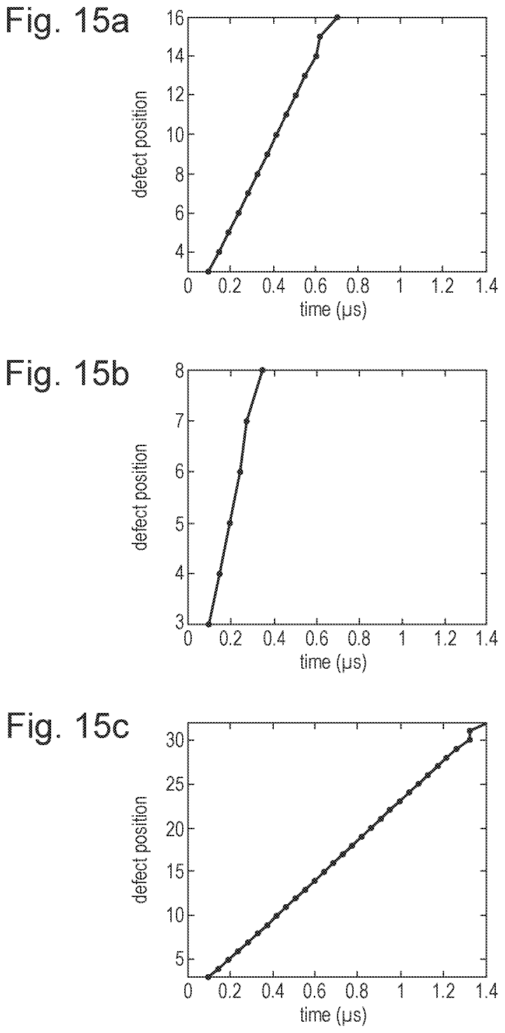

FIGS. 15a to 15c are graphs of position of an impedance discontinuity against time-of-flight in respect of echo signals derived for magnetoinductive waveguides where the number of resonant circuit elements is 16, 8 and 32, respectively;

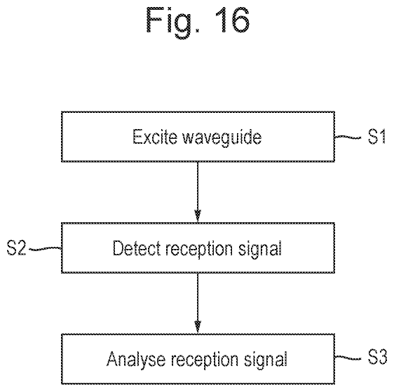

FIG. 16 is a flowchart of a method of determining a location of conductive material in the vicinity of a magnetoinductive waveguide;

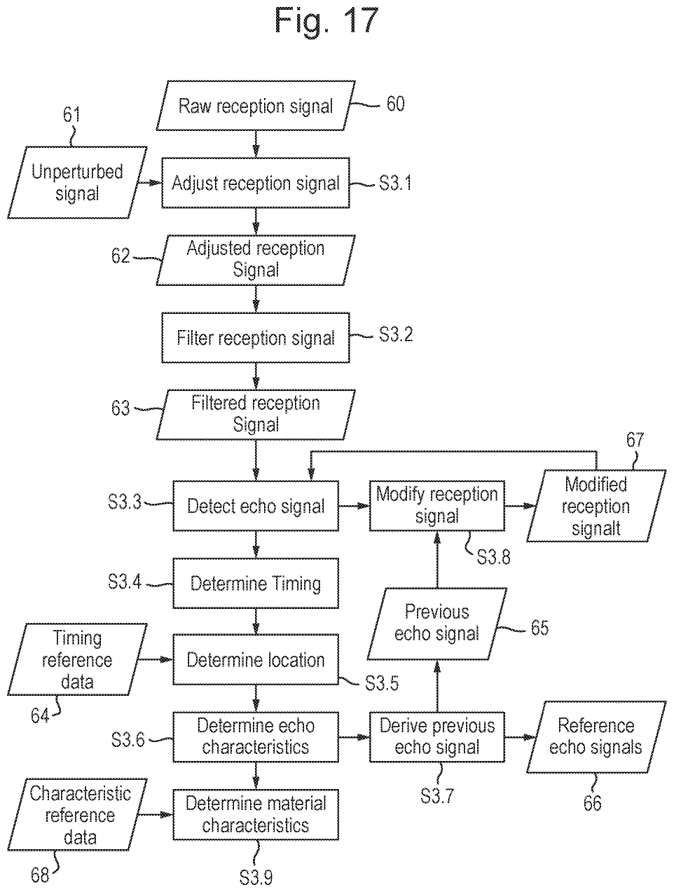

FIG. 17 is a flow chart of a step of analysing a reception signal within the method of FIG. 16;

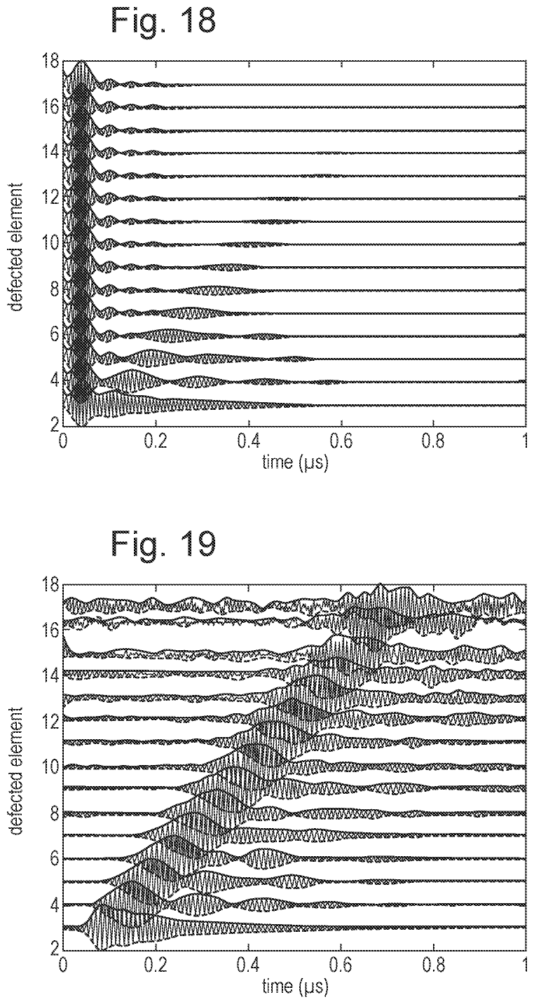

FIGS. 18 and 19 are plots of experimental results showing raw reception signals and adjusted reception signals, respectively, for impedance discontinuities at each resonant circuit element;

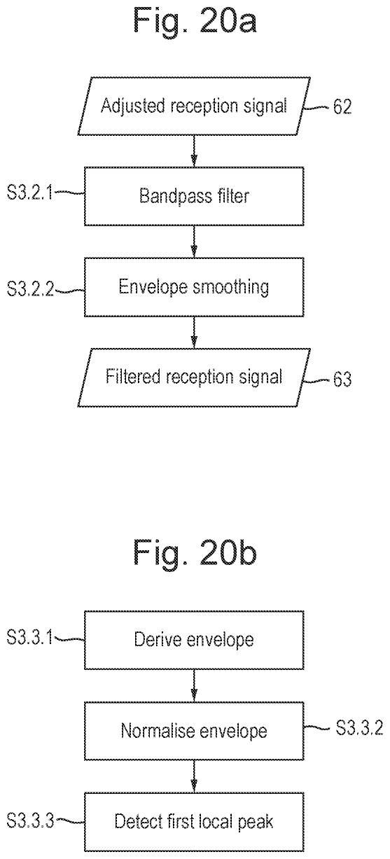

FIG. 20a is a flow chart of a step of filtering the adjusted reception signal within the method of FIG. 17, and FIG. 20b is a flow chart of a step of detecting an individual echo signal in the filtered reception signal, within the method of FIG. 17;

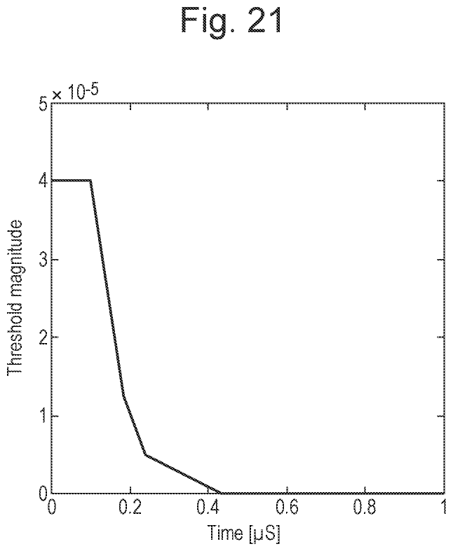

FIG. 21 is a graph of a threshold for peak selection against time;

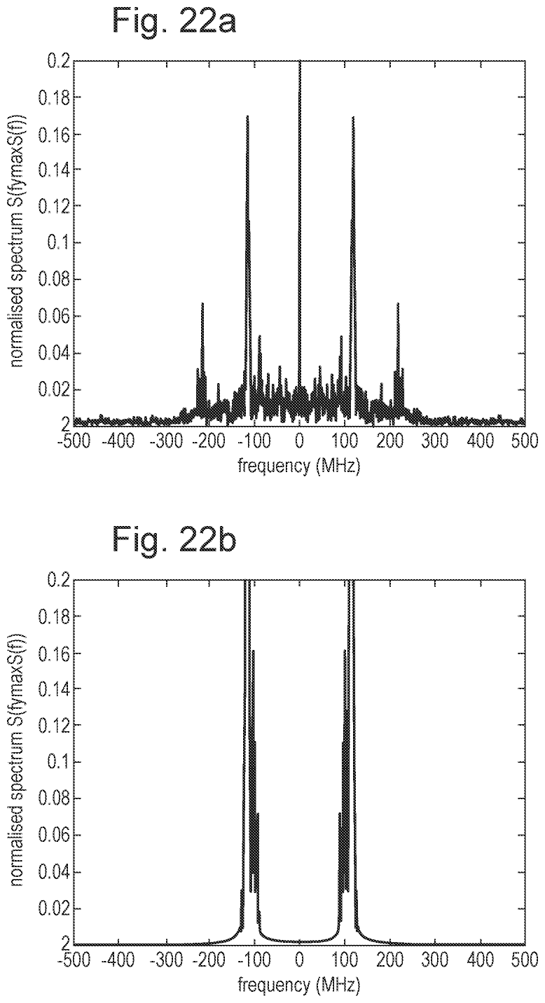

FIGS. 22a and 22b are graphs for frequency spectra of an experimental adjusted reception signal including an impedance discontinuity at resonant circuit element no. 17 before and after bandpass filtering;

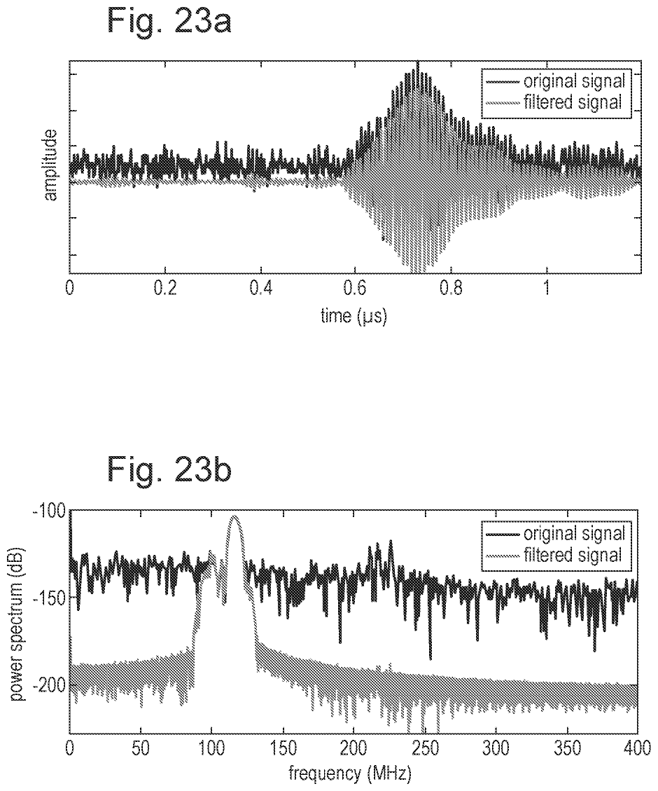

FIGS. 23a and 23b are graphs of the time domain signal and the power spectral density, respectively, of the signals shown in FIGS. 22a and 22b;

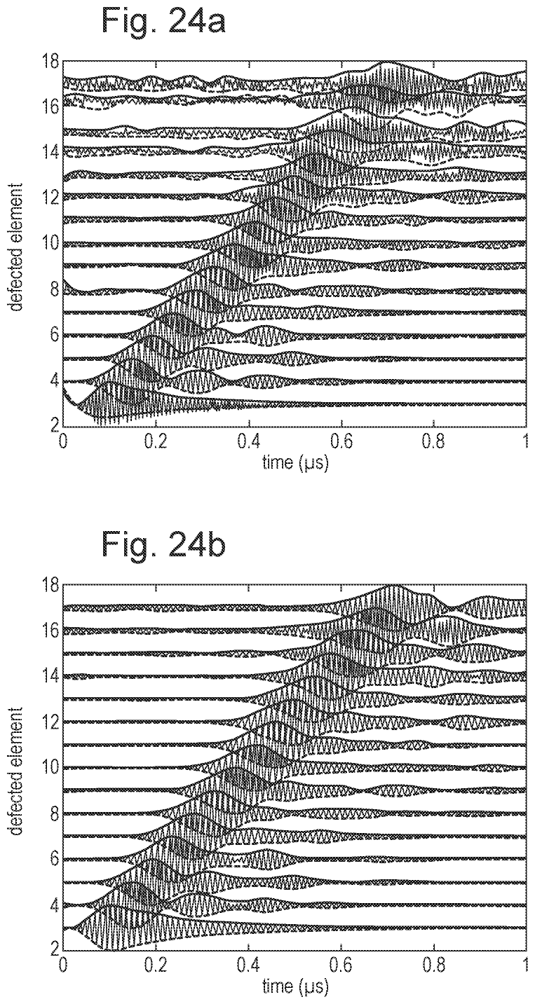

FIGS. 24a and 24b are plots of experimental results showing an unfiltered adjusted reception signal and a filtered adjusted reception signal, respectively;

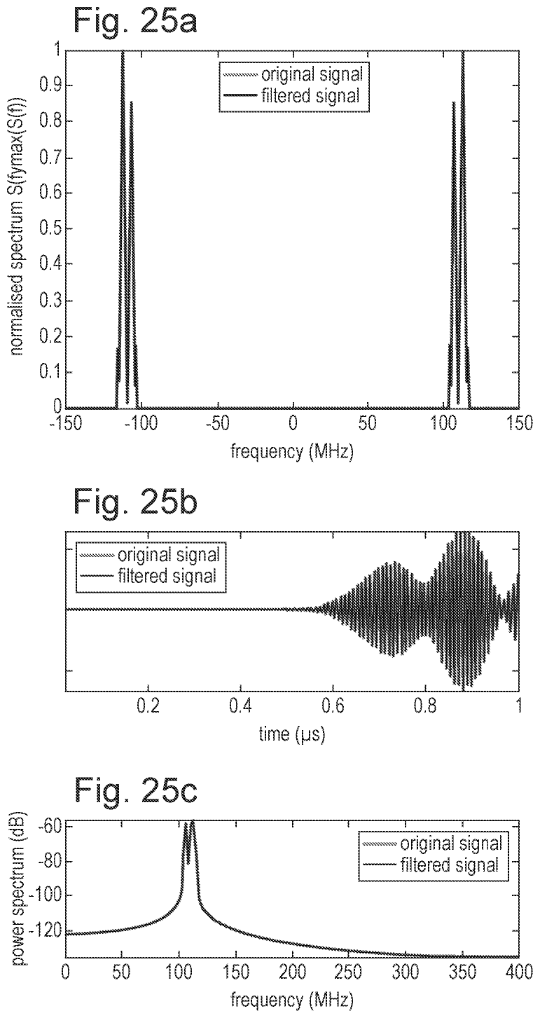

FIGS. 25a to 25c are graphs of theoretical results for frequency spectra, time domain signals and power spectral density, respectively, of an adjusted reception signal including an impedance discontinuity at resonant circuit element no. 17 before and after filtering;

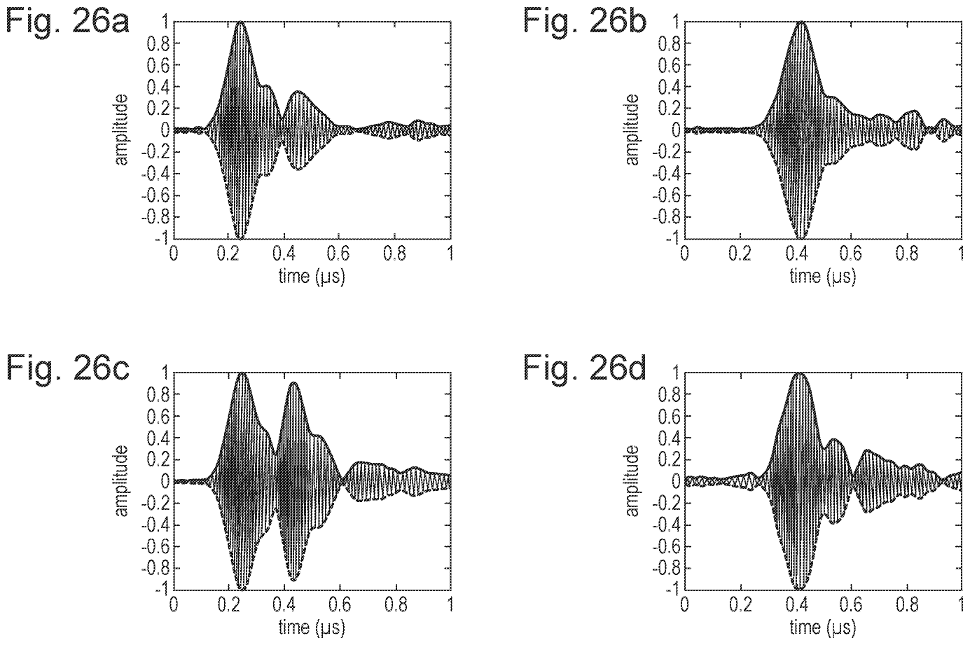

FIGS. 26a to 26d are graphs of experimental results for, respectively, the adjusted reception signal for an impedance discontinuity at resonant circuit element no. 6, the adjusted reception signal for an impedance discontinuity at resonant circuit element no. 10, the adjusted reception signal for an impedance discontinuity at resonant circuit element nos. 6 and 10, and the adjusted reception signal for an impedance discontinuity at resonant circuit element nos. 6 and 10 modified to remove the echo signal for the impedance discontinuity at resonant circuit element no. 6;

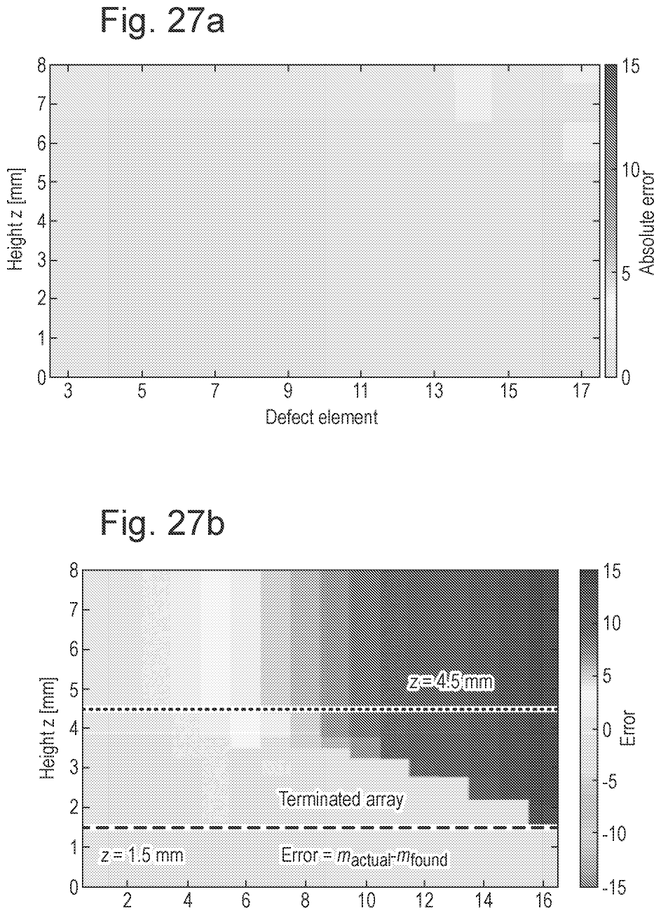

FIG. 27 is a pair of graphs of the absolute error in the determined location of an impedance discontinuity, calculated as the number of resonant circuit elements away for (a) experimental results using the time-domain approach presented herein and (b) a frequency-domain localisation found using a terminated array of resonant circuit elements adapted from Reference [3];

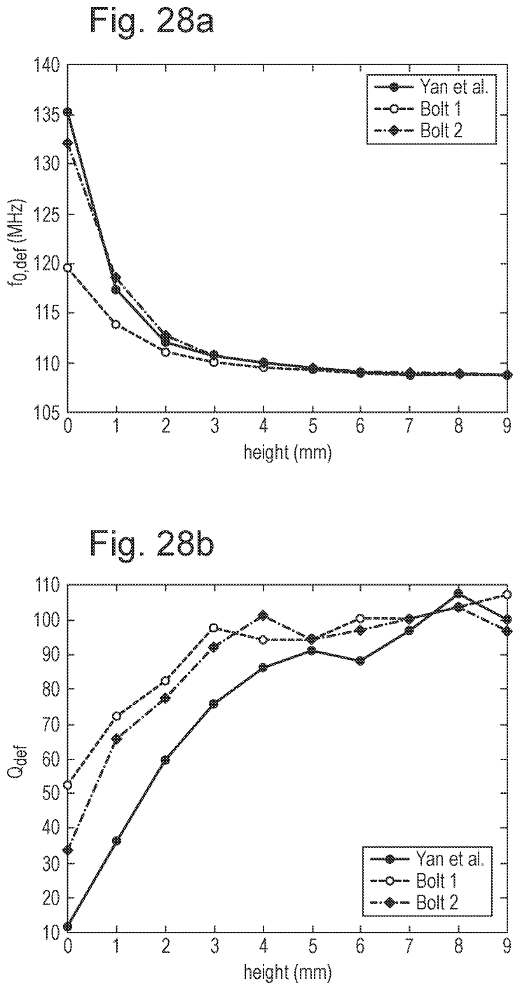

FIGS. 28a and 28b are graphs of experimentally derived measurements of resonant frequency and quality factor, respectively, of a signal in a resonant circuit element having a conductive body in its vicinity, against the axial spacing of the conductive body from the coil of the resonant circuit element;

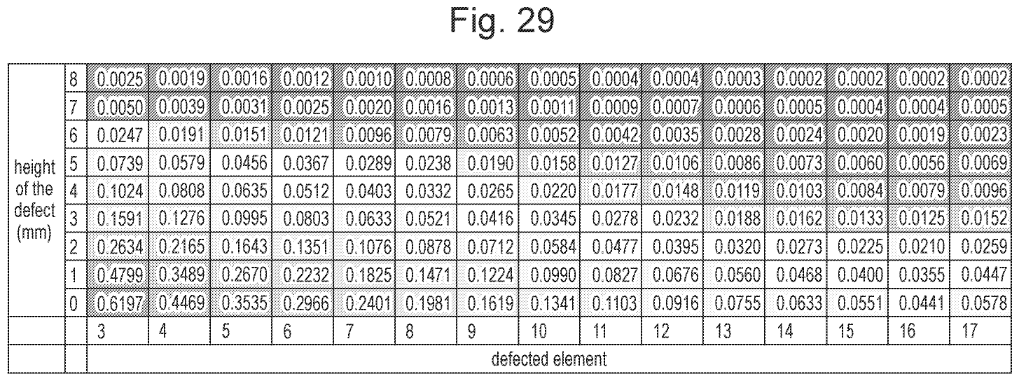

FIG. 29 is a reflection coefficient matrix for impedance discontinuities at different resonant circuit elements and at different axial spacings (heights);

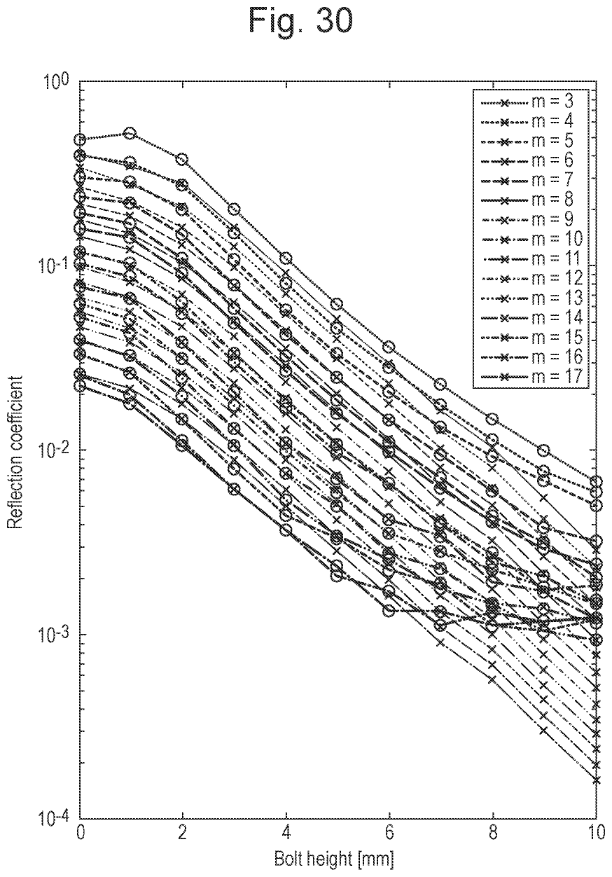

FIG. 30 is a graph of peak reflection coefficients against vertical spacing (referred to as height) of a conductive body from a resonant circuit element for multiple resonant circuit elements in a magnetoinductive waveguide, which may be used as characteristic reference data;

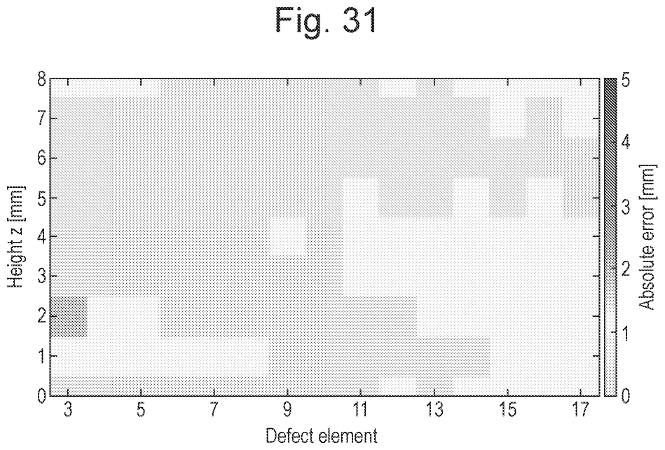

FIG. 31 is a plot of the absolute error in the vertical spacing through direct comparison of experimental data and the analytical model.

FIG. 1 shows a magnetoinductive reflectometry apparatus 30 comprising a magnetoinductive waveguide 31 that is used to detect the location of conductive material. The magnetoinductive waveguide 31 comprises an array of resonant circuit elements 32 that are magnetically coupled together. In FIG. 1 the resonant circuit elements are numbered 1 to N, where Nis any suitable number, for example 20. As described in more detail below, magnetoinductive waves may propagate along the magnetoinductive waveguide 31.

In this example, the resonant circuit elements 32 comprise coils 33 in a planar configuration, and the coils 33 are shaped as split-ring resonators. This configuration provides magnetic coupling between the resonant circuit elements 32 through the magnetic fields generated by the coils 33. In addition, the magnetoinductive waveguide 31 may be arranged in a flexible sheet, which is advantageous when applied to applications for sensing irregularly shaped objects, for example a body in a biomedical application. However, in general the resonant circuit elements 32 may take any form which provides magnetic coupling therebetween. For example, the coils 33 may have a different configuration, such as an axial configuration and/or the coils 33 may take other forms. The form of the coils 33 may be chosen to adapt the resonant properties of the resonant circuit elements 32.

The magnetoinductive waveguide 31 may have a biomedical application, with the benefit that the magnetoinductive waves used for sensing propagate without the need for a continuous metal path and without the need to individually excite every resonant circuit element 32.

In this example, the array is a one-dimensional array. However, in general the techniques disclosed herein may also be applied to two-dimensional or three-dimensional arrays of resonant circuit elements.

FIG. 1 shows a conductive body 40 in the vicinity of the magnetoinductive waveguide 31, as an example of conductive material. In general, a wide range of other forms of conductive material may be sensed, and subsequent references to the conductive body 40 should be taken as generalised to conductive material.

While the conductive body 40 is a discrete element, in some applications the conductive material may be part of a continuous object, for example part of the body such as the chest, in which case the conductive material may be water or other inhomogeneities in a lung. In that case, use of magnetoinductive waves and a magnetoinductive waveguide 31 that is flexible can provide a low-cost, quick, and non-invasive technique to detect abnormalities in vivo. The current solutions to detect water in the lungs may typically involve CT (computed tomography) or MRI (magnetic resonance imaging) scans which are time-consuming procedures and in the case of CT use harmful X-ray radiation. Whilst magnetoinductive reflectometry cannot be a substitute for the detailed imaging that CT scans give, it can provide an intermediary step and potentially avoid X-ray exposure altogether for some cases.

The resonant circuit elements 32 may have identical properties. The conductive body 40 is in the vicinity of a resonant circuit element 32, in particular within the magnetic field generated by the coil 33. As a result the conductive body 40 creates an impedance discontinuity in that resonant circuit element 32. The impedance discontinuity causes reflection of magnetoinductive waves propagating in the magnetoinductive waveguide 31. Thus, injected magnetoinductive waves propagating in the magnetoinductive waveguide 31 are reflected to create reflected magnetoinductive waves that propagate in the opposite direction.

Herein, a resonant circuit element 32 having an impedance discontinuity is referred to as a “defect”. This is simply because the impedance of the resonant circuit element 32 of which the conductive object is in the vicinity has been changed by the conductive body 40 (or other conductive material) and herein does not refer to an physical defect in the components of the resonant circuit element 32.

In general, the configuration of the magnetoinductive waveguide 31 may be varied with regard to the application and the conductive material to be located. By way of non-limitative example, experimental results discussed herein were derived for a magnetoinductive waveguide 31 having the following parameters: coil side length d=10.5 mm, f₀=108.8 MHz, Q=107.4, coupling coefficient κ=−0.13, coil inductance L=20 nH.

The magnetoinductive reflectometry apparatus 30 includes a signal generator 34 that is used to excite the magnetoinductive waveguide 31 and so inject the injected magnetoinductive waves into the waveguide 31. The signal generator 34 is arranged within a feeding resonant circuit element 35 arranged at the input end of the magnetoinductive waveguide 31, being one of the resonant circuit elements 31 of the array numbered 1 in FIG. 1, so excites the magnetoinductive waveguide 31 directly. In this example, a single feeding resonant circuit element 35 is used, but as an alternative plural feeding resonant circuit elements 35 may be used.

Such direct excitation removes background flux from excitation methods and ensures strong input signals. This technique avoids inductive excitation via a transmission antenna, which would disperse a magnetic field radially and result in a weaker excitation signal, and risk coupling with the receiving antenna 50 described below. Eliminating coupling between antennae reduces the need to consider background flux, and provides a more comprehensive image of the echo signal. Direct excitation also provides a higher voltage to the feeding resonant circuit element 35, hence stronger reflections are received back at reception resonant circuit element 36 despite the natural attenuation as the magnetoinductive wave propagates. Stronger reflection echoes are particularly important for the experimental readings, in order to provide a higher signal-to-noise ratio.

The signal generator 34 excites the magnetoinductive waveguide 31 with an input signal in the form of a pulse. As a result the injected magnetoinductive waves propagating along the magnetoinductive waveguide 31 also take the form of a pulse, which spreads in accordance with dispersion of magnetoinductive waves of different frequencies that are components of the pulse.

The pulse of the input signal may in general be of any shape. In one example, the shape may be rectangular. This is convenient because a rectangular pulse shape is easy to generate. The shape is rectangular in the following examples, but this is merely for illustration and not limitative. By way of non-limitative example, experimental results discussed herein were derived for a square pulse having parameters: amplitude V=10 Vpp, frequency f=100 kHz, duty cycle 50%, and phase 0 degrees.

A possible, alternative shape for the pulse is Gaussian. This allows for optimisation of the waveform of the input magnetoinductive waves to ease the post-processing of experimental data and help isolate echo signals more accurately. In particular, use of discrete Gaussian pulses may avoid the overlapping of reflection echo signals, and be particularly useful when localising multiple defects. In particular, the Fourier Transform of a Gaussian pulse results in another Gaussian waveform, so would eradicate the decaying sinc function that is attributable to the Fourier Transform of a square wave (discussed below), and remove superposition between decaying sinc functions and peaks from successive defects.

To understand the fundamental physics behind the propagation of magnetoinductive waves, we must first appreciate the behaviour of individual resonator circuit elements 32, as examples of meta-atoms and in this example are split-ring resonators (SRR), in which the coil 33 is shaped as a split-ring, and as a result has a strong resonant response when exposed to AC magnetic fields, resonating at a frequency of f₀. Such meta-atoms are the building blocks of metamaterials and can be arranged into 1D arrays, 2D surfaces, or 3D structures. The overall electromagnetic response of the metamaterial arises from both the properties and responses of the individual meta-atoms and their interactions, as described in Reference [4].

The resonant circuit elements 32 may typically consist of a coil ring and capacitor and can be modelled using an LCR circuit, as shown in FIG. 2, where V represents the AC voltage used to excite the meta-atom. From this model we can compute the current through the coil, I, using Ohm's Law:

$$I = \frac{V}{{Z}_{0}} = \frac{V}{R + j ω L + \frac{1}{j ω C}} \qquad ( 1 )$$

where Z₀ denotes the self-impedance of the LCR circuit, R the resistance, L the self-inductance, C the total capacitance (the SRR self-capacitance plus the capacitance of the tuning capacitor), ω=2πf) the angular frequency, and f the frequency.

Progressing from this relationship, we can derive the characteristics of the meta-atom in terms of its resonant frequency, ω, and quality factor, Q, as follows:

$${ω}_{0} = \frac{1}{\sqrt{LC}} , Q = \frac{{ω}_{0} L}{R} \qquad ( 2 )$$

The concept of magnetoinductive wave propagation relies on the interaction between meta-atoms via the mutual inductance of neighbouring coils; this is fundamentally based on the physics of magnetic coupling.

As discussed, magnetoinductive waves are present when there is magnetic coupling between neighbouring meta-atoms. These waves are considered slow waves, meaning they move at a relatively (compared to the speed of light) slow velocity, for example, of about 500 km/s. These waves can travel along a magnetoinductive waveguide as described in Reference [1] which is formed from a periodic arrangement of coupled meta-atoms. In this case, we consider 1D magnetoinductive waveguide, i.e., meta-atoms arranged in an array. The magnetoinductive waveguide allows a magnetoinductive wave to propagate through the structure in a narrow passband centred around the resonant frequency.

FIG. 3 provides the circuit diagram for two coupled coils, labelled 1 and 2, where M denotes the mutual inductance between the individual circuits, and V is the excitation voltage given to circuit 1. Kirchoff's equations for each coil can be written in the following form:

$$V = {Z}_{0} {I}_{1} + j ω {MI}_{2} 0 = {Z}_{0} {I}_{2} + j ω {MI}_{1} \qquad ( 3 )$$

Solving Eqn. (3) we obtain explicit expressions for both currents:

$${I}_{1} = \frac{V}{{Z}_{0} - \frac{j ω {M}^{2}}{{Z}_{0}}} , {I}_{2} = - \frac{j ω M}{{Z}_{0}} {I}_{1} \qquad ( 4 )$$

We can now observe the changing behaviour of a single coil versus a coupled coil system. FIG. 4a shows the resonance curve for a single coil with a clear single peak at the resonant frequency. FIG. 4b illustrates that for two coupled coils we observe two peaks, using the expressions derived in Eqn. (4).

This behaviour is analogous to a coupled pendulum where we would find two eigenmodes of behaviour, each simulated by a different excitation frequency. When two coils are coupled we observe two resonance peaks in I₁ and I₂ in coil 1 and coil 2 respectively. Extending this idea, multiple coils can be linearly arranged (forming a waveguide) and coupled to observe multiple peaks. Eventually, these peaks appear to combine and provide a bandpass filter that only allows certain frequencies to pass through, this being a notable property of a magnetoinductive waveguide.

As the coils are magnetically coupled, a change in the current through one coil induces a change in the voltage of the other. Let us consider a 1D waveguide with the first coil being excited either by a loop antenna placed nearby or via a direct feed. This induces an emf in the first coil, thus also producing a current. This current then induces its own magnetic flux, which is experienced by the neighbouring meta-atom, and an emf is induced in the second coil. Faraday and Lenz's Laws mean that a magnetic field is produced by the second coil, which its subsequent neighbouring coil then interacts with. This coil-by-coil excitation propagates along the structure as a wave, a magnetoinductive wave. The extent of the coupling between neighbouring coils depends on their mutual inductance M. The mutual inductance varies depending on the geometry of the array and the circuit parameters. In this case we will only consider nearest neighbouring coupling. FIG. 5 provides a circuit diagram of a section of the magnetoinductive waveguide, where nearest-neighbour coupling is obeyed and coils are spaced a distance d apart.

The next step is to consider the dispersion of magnetoinductive waves. Dispersion is the relationship between wave frequency, ω, and wavenumber, k, (k=β−jα, where β is the propagation coefficient and α the attenuation coefficient). Visualising the dispersion relations can be extremely insightful in understanding how a magnetoinductive waveguide behaves like a bandpass filter.

Firstly, Kirchoff's Law can be used to find the general form for the current in element n in a system of nearest-neighbour coupled coils as shown in FIG. 5. By considering each coil that affects Iₙ in turn, we obtain the following equation for the total current in element n:

$${Z}_{0} {I}_{n} + {Z}_{M} ( {I}_{n + 1} + {I}_{n - 1} ) = 0 \qquad ( 5 )$$

Assuming current takes the form Iₙ=I₀ exp (j(ωt−kdn)), where Iₙ is the current through the nth coil, t is the time, and I₀ a constant, allows us to utilise the exponential form of the cosine function and rewrite Eqn. (5) as:

$${Z}_{0} {I}_{n} + {Z}_{M} ( {I}_{n} {e}^{jkd} + {I}_{n} {e}^{- jkd} ) = 0 \to {Z}_{0} + 2 {Z}_{M} cos ( k d ) = 0 \qquad ( 6 )$$

where, Z₀ is the characteristic self-impedance of the coil, which we found earlier using the LCR circuit and Z_{M} is the mutual impedance. These parameters are given by:

$${Z}_{0} = R + j ω L + \frac{1}{j ω C} = R + j ω L ( 1 - \frac{{ω}_{0}^{2}}{{ω}^{2}} ) {Z}_{M} = j ω M \qquad ( 7 )$$

Substituting Eqn. (7) into Eqn. (6) and rearranging gives an expression for the dispersion for nearest-neighbour coupling:

$$R + j ω L ( 1 - \frac{{ω}_{0}^{2}}{{ω}^{2}} ) + 2 j ω M cos ( k d ) = 0 \frac{R}{j ω L} + 1 - \frac{{ω}_{0}^{2}}{{ω}^{2}} + κ cos ( k d ) = 0 \qquad ( 8 )$$

To obtain this expression have we considered a system with losses (i.e., R≠0), and taken κ=(2M/L) for coupling between identical meta-atoms. Now extending this analysis to non-nearest neighbour coupling (where each circuit is coupled with their nearest C neighbours) and taking the waveguide to be a low-loss medium (R=0), we derive the dispersion relation for a magnetoinductive wave:

$$1 - \frac{{ω}_{0}^{2}}{{ω}^{2}} + {\sum }_{m = 1}^{c} {κ}_{m} cos ( mkd ) = 0 \qquad ( 9 )$$

We see the cosine term is summated over each set of coupled meta-atoms and the loss term at the start has been removed. The value of κ=−0.13 can be used to derive the limits of the magnetoinductive waveguide as a bandpass filter. First considering the upper limit ωₘₐₓ which occurs when kd=0, thus cos (kd)=1, as per FIGS. 6a and 6b, gives the upper bandpass limit. Similarly, ωₘᵢₙ occurs when kd=π, hence cos(mkd)=1 or −1 if m is even or odd respectively. Substituting these values into Eqn. (9) results in the magnetoinductive waveguide bandpass limits:

$${ω}_{max} = \frac{{ω}_{0}}{\sqrt{1 + {\sum }_{m}^{C} \vert {κ}_{m} \vert}} , \\ {ω}_{min} = \frac{{ω}_{0}}{1 + {\sum }_{m}^{C} {( - 1 )}^{m} \vert {κ}_{m} \vert} \qquad ( 10 )$$

Using κ=−0.13 and the ω=2πf relationship results in fₘₐₓ=116.6 MHz and fₘᵢₙ=102.3 MHz. These limits indicate the waveguide will not allow any frequencies outside this range to propagate through the structure. Clearly, only a specific set of frequencies are able to propagate through the waveguide, and these limits match those derived above. From the expressions above (Eqn. (10), as κ increases (i.e., stronger coupling) the limits of the passband expand. FIGS. 6a and 6b provides a visualisation of the bandpass for two varying K values, where the meta-atoms in each waveguide are coupled to their nearest-neighbour, and shows the attenuation and propagation coefficients of the wavenumber.

Note that the convention when plotting the attenuation coefficient is to plot the absolute value.

The dispersion relation can also be used to derive the phase velocity, vₚ, and group velocity, v_{g} of the magnetoinductive wave. The phase velocity is the velocity at which any singular frequency component of the wave travels, and can be written as vₚ=ωk. Group velocity is the velocity at which the entire wave of information travels, i.e., the overall envelope of the wave, and is defined as v_{g}=dω/dk. Differentiating Eqn. (9) with respect to k gives the group velocity:

$${v}_{g} = \frac{{ω}^{3}}{2 {ω}_{0}^{2}} d {\sum }_{m}^{C} m {κ}_{m} sin ( mkd ) \qquad ( 11 )$$

FIG. 6c illustrates a breakdown of the velocity of each frequency component. We can see that for nearest-neighbour coupling the maximum group velocity is approx. 500 km/s which occurs at the resonant frequency, and for frequencies outside the bandpass limits the wave exhibits a very low velocity, so these frequencies are essentially not propagating.

Given that we can calculate the group velocity of the wave, we can now determine the distance travelled along the magnetoinductive waveguide by measuring the time taken between the injected and reflected magnetoinductive waves, measured from the start of the array. A conductive material placed above an element of the array causes a partial reflection of the wave. Hence, combining the velocity and reflection arrival time will allow us to locate the conductive material.

Using this theory, an analytical model of the magnetoinductive waveguide 31 may be created to understand how a magnetoinductive wave travels along a magnetoinductive waveguide 31 when excited with a pulse, which is square in this example for illustration, as follows.

First, we create a square pulse to represent the excitation in the time domain, vᵢₙ(t), as shown in FIG. 7a. Second, we compute the Fast-Fourier Transform (FFT) of the square wave input signal to produce the sinc wave frequency spectra shown in FIG. 7b, Vᵢₙ(f).

$${Z}_{two coils} = [ \begin{matrix}{Z}_{0} & {Z}_{M} \\ {Z}_{M} & {Z}_{0}\end{matrix} ] \to Z = [ \begin{matrix}{Z}_{0} & {Z}_{M} & 0 & 0 & … & 0 \\ {Z}_{M} & {Z}_{0} & {Z}_{M} & 0 & … & 0 \\ 0 & {Z}_{M} & {Z}_{0} & {Z}_{M} & … & 0 \\ 0 & 0 & {Z}_{M} & {Z}_{0} & … & 0 \\ ⋮ & ⋮ & ⋮ & ⋮ & ⋱ & {Z}_{M} \\ 0 & 0 & 0 & 0 & {Z}_{M} & {Z}_{0}\end{matrix} ] \qquad ( 12 )$$

Next, we must compute the impedance Z matrix for coupled coils. Above, we derived the mutual inductance relations for two coupled coils, shown in Eqn. (12). Extending this idea, we can create the Z matrix for an array of N coils, each coupled with their nearest neighbours, as seen in Eqn. (12), where Z₀ is the self-impedance of a coil, and Z_{M} is the mutual impedance between nearest neighbours. This gives us an N×N tri-diagonal matrix with Z₀ down the diagonal, Z_{M} on either side of the main diagonal, and 0 elsewhere.

To directly compare with Reference [3], an array of 20 elements may be used, hence N=20 in the examples herein. Rearranging Ohm's Law to obtain I=Z⁻¹V allows us to derive the frequency spectra for the current vector, I(f). Here we define V=[Vₑₓ(f) 0 0 . . . 0]^{T}, where Vₑₓ(f) is the excitation voltage given to the first element at frequency f. The inverse FFT is taken to obtain the current in the time domain, I(t), for each element in the waveguide. The Fourier Transform of a square wave gives a sinc function, which is observed by the analytical modelling of the magnetoinductive wave, discussed in the next section.

As described above, we can find the current in each coil in the time domain. FIG. 8 shows the analytically-produced results, normalised to their own absolute maximum, so that the values of the current range from 0 to 1 for all elements—providing a clear visualisation of the propagating of the injected magnetoinductive wave followed by a reflection due to the end of the array (at element 20) at around L=0.48 μs. A smooth envelope has been also applied to all of the signals. Normalising and applying an envelope allow us to see the weaker amplitudes more clearly and emphasise where their maxima lie. Whilst this visualisation is useful, the most important insight is the signal through element 2, as this is where the reception antenna 50 will be positioned—i.e., we will only monitor the signal through element 2, given the impracticality of having a receiving antenna on every element of the waveguide. We shall call this the theoretical unperturbed signal; namely, the signal through element 2 when no defect is present in the structure, as seen in FIG. 8 where element number=2. The root of our localisation model is grounded in identifying how the signal through element 2 is dependent on the defect position and how this compares to this unperturbed signal.

The envelopes in FIG. 8 highlight the sinc wave shape carrying the cosine signal of the injected magnetoinductive waves, occurring at successive resonant circuit elements 32 at later times as the magnetoinductive waves propagate.

We now have a theoretical model that can predict the shape and structure of the magnetoinductive wave in every element at any instance, and we can use this model to validate experimental results and to create the reference data described below.

Now that we understand how an unperturbed signal propagates through a waveguide we can begin to model the change caused by a defect. The introduction of a conductive object on top of an SRR (here a metal bolt is used) into the system essentially creates a ‘defected element’, causing the parameters of the nearest SRR to change to a new resonant frequency, f_{0,def}, and to a new quality factor, Q_{def}. This causes an impedance discontinuity in the magnetoinductive waveguide and a partial reflection of the magnetoinductive wave at the location of the defect. The reflected wave will travel back towards the start of the waveguide, where we can detect its arrival timing (corresponding to time-of-flight) to obtain the position of the conductive object. A library of data is created using theoretically generated waves and employed to localise experimental defects. In order to compare the experimental waves to the theoretical data library a data-cleansing method is proposed, which is experimentally proven to be highly accurate for a range of defect strengths.

The earlier modelling can be modified to include the added defect. A defect present on element n will cause the self-impedance of element n to change from Z₀ to Z_{def}. Hence, in the impedance matrix, Z_{n.n} becomes Z_{def} to account for this defect. Placing a metal bolt directly onto the structure means we must define a new resonant frequency, f_{0,def} of 119.55 MHz and quality factor, Q_{def} of 52.26, of the now ‘defected’ element. The resonant frequencies and quality factors are determined through experimental empirical methods.

Amending our earlier analytical model to use this new Z matrix and computing the theoretical waves with a defect present gives the signals shown in FIGS. 9a and 9b, where the signal through each element is shown, for a defect at element numbered 7 and element numbered 14. As illustrated in the example of FIGS. 9a and 9b, the signals in the resonant circuit elements 32 include the pulse of the injected magnetoinductive wave illustrated in FIG. 8, and additionally now also echo signals superimposed thereon. The echo signals correspond to reflected magnetoinductive waves generated by reflection of the injected magnetoinductive waves at impedance discontinuities created by conductive material in the vicinity of respective resonant circuit elements 32. The echo signals can be seen to occur at resonant circuit elements 32 numbered 7 and 14 respectively at later times as the reflected magnetoinductive waves travels back along the magnetoinductive waveguide 1.

Next we consider a theoretical model of the frequency response of the reflection coefficient, which is useful in the detection of material characteristics of the conductive material as discussed further below.

For use in this model, FIG. 10 shows a section of a magnetoinductive waveguide 31 comprising an infinite array of resonant circuit elements 32 numbered −N to N, which have a uniform impedance Z₀ except that the resonant circuit element 32 numbered 0 has an impedance discontinuity and so has an impedance Zo, def. Thus:

$$Z = \{ \begin{matrix}{Z}_{0 , def} & for n = 0 , \\ {Z}_{0} & for n \neq 0.\end{matrix} \qquad ( 13 )$$

We assume that the capacitance of the resonant circuit element 32 having an impedance discontinuity remains the same, but both resistance and inductance are changed in accordance with equation (2), such that:

$${Z}_{0} = {R}_{0} + j ( ω {L}_{0} + \frac{1}{ω {C}_{0}} ) , {Z}_{0 , def} = {R}_{def} + j ( ω {L}_{def} + \frac{1}{ω {C}_{0}} ) \qquad ( 14 )$$

Mutual inductance M is assumed constant throughout the magnetoinductive waveguide 31, such that mutual impedance may be denoted as Z_{M}=jωM throughout the magnetoinductive waveguide 31. On the input side of the resonant circuit element 32 having an impedance discontinuity, the signal is considered to comprise two magnetoinductive waves, being the incident wave travelling forwards and the reflected wave travelling backwards. On the output side of the resonant circuit element 32 having an impedance discontinuity, only the transmitted wave travelling forwards is present. A constant wavenumber between the three waves is assumed as a property of the uniformity of the magnetoinductive waveguide 31, with wavenumber governed by the dispersion equation:

$${Z}_{0} + 2 {Z}_{M} cos ( k d ) = 0 \qquad ( 15 )$$

where k is wavenumber and d is the distance between centres of adjacent resonant circuit elements 32. The current in element n can be written as:

$${I}_{n} = \{ \begin{matrix}{I}_{00} ( {e}^{- jkdn} + R {e}^{jkdn} ) & for n \leq 0 , \\ {I}_{00} {Te}^{- jkdn} & for n > 0.\end{matrix} \qquad ( 16 )$$

Applying Kirchoff's equations to the resonant circuit element 32 having an impedance discontinuity gives:

$${Z}_{0 , def} {I}_{0} + {Z}_{M} ( {I}_{- 1} + {I}_{1} ) = 0 \qquad ( 17 )$$

and to the adjacent resonant circuit element 32 numbered 1:

$${Z}_{0} {I}_{1} + {Z}_{M} ( {I}_{0} + {I}_{2} ) = 0 \qquad ( 18 )$$

Substituting n=−1, 0, 1, 2 into Eqn. (16):

$$\{ \begin{matrix}{I}_{- 1} = {I}_{00} ( {e}^{jkd} + R {e}^{- jkd} ) \\ {I}_{0} = {I}_{00} ( 1 + R ) \\ {I}_{1} = {I}_{00} {Te}^{- jkd} \\ {I}_{2} = {I}_{00} {Te}^{- 2 jkd}\end{matrix} \qquad ( l9 )$$

Kirchoff's equations in Eqn. (17) and (18) can be rewritten using the currents in Eqn. (19) as:

$${Z}_{0 , def} ( 1 + R ) + {Z}_{M} ( {e}^{jkd} + R {e}^{- jkd} + T {e}^{- jkd} ) = 0 \qquad ( 20 )$$

$${Z}_{0} T {e}^{- jkd} + {Z}_{M} ( 1 + R + T {e}^{- j 2 kd} ) = 0 \\ Eqn . ( 21 ) can be rearranged as \qquad ( 21 )$$

$$T {e}^{- jkd} ( {Z}_{0} + {Z}_{M} {e}^{- jkd} ) + {Z}_{M} ( 1 + R ) = 0 \qquad ( 22 )$$

which can be further simplified using the dispersion equation (15) which can be rewritten as:

$${Z}_{0} + {Z}_{M} {e}^{- jkd} = - {Z}_{M} {e}^{jkd} \qquad ( 23 )$$

Using Eqn. (23), Eqn. (22) simplifies to:

$$T = 1 + R \qquad ( 24 )$$

which can be used to obtain an expression for R from Eqn. (20) as:

$$R = - \frac{{Z}_{0 , def} + 2 {Z}_{M} cos ( jkd )}{{Z}_{0 , def} + 2 {Z}_{M} {e}^{- jkd}} \qquad ( 25 )$$

Finally, we arrive at:

$$R = - \frac{Δ}{Δ - 2 j {Z}_{M} sin ( kd )} \qquad ( 26 )$$

where defect impedance has been rewritten in terms of the magnitude Δ of the impedance discontinuity, where Δ=Z_{0,def}−Z₀. The dispersion equation as in Eqns. (15) and (23) has been used to further simplify the algebra. The reflection coefficient R is clearly dependent on the magnitude of the impedance discontinuity, and it reduces to zero when no impedance discontinuity is present (Δ=0).

By way of illustration, FIG. 11 shows an example of the frequency response of (a) the magnitude of reflection coefficient R and (b) the phase of reflection coefficient R, in the passband under the assumption that for frequency values within the passband wavenumber k can be approximated as entirely real, which is a reasonable assumption in the passband where attenuation coefficient α is relatively low. In in this example, the spacing of the conductive material from the resonant circuit element 32 is z=2 mm, the wavenumber k is assumed entirely real across the passband, the parameters used for the resonant circuit element 32 having an impedance discontinuity are: f_{0,def}=119.2 MHZ, Q_{def}=65, and the parameters used for the other resonant circuit elements 32 are f₀=114.76 MHz, Q=95.

It is clear that the magnitude of the reflection coefficient changes non-linearly with frequency across the passband, greatly complicating any effort to adequately encompass the total reflection from all frequencies. The phase of the reflection coefficient also varies with frequency, creating further difficulties as each frequency component of the signal will experience a different phase shift.

To characterise a conductive object a time-domain method may be instead chosen. This has the advantage of encompassing all frequencies but has the disadvantage that it is reliant on accurately identifying the correct reflection peak using localisation. We introduce the peak reflection coefficient ρ defined as a ratio of the peak amplitude B of the echo signal to the peak amplitude A of the unperturbed reception signal derived from the injected magnetoinductive waves alone, given by:

$$ρ = B / A , \qquad ( 27 )$$

As an illustration of this, FIG. 12 shows examples of analytically derived reception signals and their upper envelopes for (a) the unperturbed reception signal and (b) an echo signal for a conductive object with no spacing from the resonant circuit element 32 numbered 5.

The magnetoinductive reflectometry apparatus 30 is configured to detect a reception signal as follows.

The reception signal is detected from a reception resonant circuit element 36 at the input end of the magnetoinductive waveguide 31, being one of the resonant circuit elements 32 of the array numbered 2 in FIG. 1. As the feeding resonant circuit element 35 is located before the reception resonant circuit element 36 in the direction of propagation of the injected magnetoinductive waves, this allows the reception signal to be detected in a manner that reduces the impact of the excitation on the echo signal. This improves the detection of the echo signal, allowing the location to be more accurately determined.

The magnetoinductive reflectometry apparatus 30 includes a reception antenna 50, which is spaced from the reception resonant circuit element 36 and detects the reception signal. This avoids direct detection of the reception signal using components within the reception resonant circuit element 36, which reduces the impact of the detection on the injected magnetoinductive waves in the magnetoinductive waveguide 31.

The reception antenna 50 is spaced from the reception resonant circuit 36 by an spacing in an axial direction of the coil 33 at which the coupling between the reception antenna 50 and the resonant circuit elements 32 adjacent to the reception resonant circuit element 36 is minimised. It has been found through experimental trials that when the reception antenna 50 is placed at a certain spacing from the reception resonant circuit element 36 the coupling between the reception antenna 50 and the adjacent resonant circuit elements 32 (numbered 1 and 3 in FIG. 1) may be minimised. Hence, by setting the receiving antenna 50 to this spacing, we eradicate any extra signal due to unwanted element-to-antenna coupling and isolate the pure reception signal through the reception resonant circuit element 36. Note, this is not to be confused with element-to-element coupling between the resonant circuit elements 32. Element-to-element coupling is what causes magnetoinductive wave propagation. However, at certain positions, the 3D distribution of magnetic fields causes additional element-to-antenna coupling, where the reception antenna 50 receives magnetic flux emitted by neighbouring elements. This coupling can be extremely strong and hence can obscure the signals from magnetoinductive wave in the reception resonant circuit element 36, so using this particular spacing between the reception antenna and the magnetoinductive waveguide eradicates this.

The verification of the this ideal spacing and the location of the feeding resonant circuit element 35 before the reception resonant circuit element 36 is discussed as follows.

There is mutual coupling between the resonant circuit elements 32. In an experimental example, the waveguide exhibits nearest-neighbour coupling of κ=−0.13 but there is also coupling between the reception antenna 50 and resonant circuit elements 32, this being how the reception antenna 50 detects the reception signal. Given that each resonant circuit element 32 disperses its own magnetic flux, we might expect the resonant circuit elements 32 to additionally detect flux from adjacent resonant circuit elements 32. This was tested by directly exciting a single resonant circuit element 32 moving the reception antenna 50 laterally to see how much signal is detected at different positions. FIGS. 13a to 13c show the signal detected as the antenna moves laterally.

For this experiment a single resonant circuit element 32 was used, rather than the whole magnetoinductive waveguide 31, as we wanted to calculate the flux dispersion from one resonant circuit element 32, without considering magnetoinductive wave propagation. By considering the flux dispersion we can find the ideal spacing of the reception antenna 50 to minimise the net flux from the single resonant circuit element 32. We see that, after the 10.5 mm spacing (see FIG. 13a), as the reception antenna 50 moves away from the single resonant circuit element 32, the amplitude of the detected reception signal decreases, agreeing with the understanding that magnetic flux disperses according to an inverse square law. However, FIG. 13a shows that for a lateral distance of 10.5 mm there very little net flux being received through the reception antenna 50 at the ideal spacing. Noting that each reception signal has been normalised to the maximum signal received by the reception antenna 50 when it sits directly over the single resonant circuit element 32, we can read off the proportion of flux from the single resonant circuit element 32 that reaches various lateral distances from the y-axes.

FIGS. 13a to 13c allow us to calculate how much flux from the single resonant circuit element 32 is being received by other resonant circuit elements 32, given the unit spacing between the resonant circuit elements 32 is 10.5 mm. Now considering the full magnetoinductive waveguide 31, the signal picked up by the reception antenna 50 at resonant circuit element 32 numbered n will be a summation of flux from nearby resonant circuit elements 32. We can use these calculations to understand the distribution of flux from a single coil, 33 and hence model the contributions of flux from adjacent resonant circuit elements 32 being received by the reception antenna 50. From FIGS. 13a to 13c we can make an equation for the signal through the reception antenna 50 in any given position:

$${S}_{n} = {α}_{1} {I}_{n} + {α}_{2} ( {I}_{n - 1} + {I}_{n + 1} ) + {α}_{3} ( {I}_{n - 2} + {I}_{n + 2} ) + {α}_{4} ( {I}_{n - 3} + {I}_{n + 3} ) \qquad ( 13 )$$

Eqn. (13) gives the signal received by the reception antenna 50, Sn, when it sits over the resonant circuit element 32 numbered n, as a summation of the currents given by each resonant circuit element 32 in the magnetoinductive waveguide 31 (as current is proportional to flux). The αᵢ coefficients account for the proportion of flux from various neighbouring elements i that are received by the reception antenna 50 over the resonant circuit element 32 numbered n, normalised to the maximum signal received by the reception antenna when it resides directly above the signal element. This ratio defines how much flux travels into adjacent resonant circuit elements 32 for a single element test, and can be used analogously to define the proportion of flux from adjacent resonant circuit elements 32 reaching the reception antenna 50 for the full magnetoinductive waveguide 31. The coefficients can be calculated as: α₁=1 (by definition), α₂≈0 (FIG. 13a), α₃=0.02 (FIG. 13b), and α₄=0.01 (FIG. 13c). Eqn. (13) can be re-written with respect to the reception antenna 50:

$${S}_{2} = 1 \cdot {I}_{2} + 0 \cdot ( {I}_{1} + {I}_{3} ) + 0.02 \cdot {I}_{4} + 0.01 \cdot {I}_{5} \qquad ( 14 )$$

We also observe a relationship between the axial spacing of the reception antenna 50 and the flux it receives. By adjusting the spacing of the reception antenna 50 as it sits above the reception resonant circuit element 36, we can find a position through which the net flux from adjacent resonant circuit elements 32 is zero, which is the ideal spacing. Where the reception antenna 50 in FIGS. 13a to 13c uses the ideal spacing and moves laterally over the magnetoinductive waveguide 31, the reception antenna 50 in FIGS. 14a to 14c remains over element 2 but varies in spacing. This provides an experimental verification that an ideal spacing exists at which the net flux through the reception antenna 50 from adjacent resonant circuit elements 32 is practically zero, and that both below and above the ideal spacing a higher flux from is received.

Given that the reception antenna 50 sits above reception resonant circuit element 36, and we have defined the ideal spacing as no flux is received from adjacent resonant circuit elements 32, we conclude that α₂≈0. As the reception antenna 50 gets further away, the magnetic flux detected will decrease (following the inverse square law), and hence as will the detected signal (by Ampere's Law). This means that αₙ>αₙ₊₁>αₙ₊₂>αₙ₊₃> . . . . Furthermore, as the feeding resonant circuit element 35 is directly excited, we also have I₁>I₂>I₃>I₄> . . . . This validates the assumption that α₁I₂ »α₃I₄, α₄I₅.

The most significant signal will come from I₁, hence by adjusting to the ideal spacing to minimise α₂ and making that assumption, we can approximate Eqn. (14) to S₂=I₂ . . . . Hence, the reception antenna 50 at the ideal spacing will only pick up flux produced by the reception resonant circuit element 36. In conclusion, the combination of the location of the feeding resonant circuit element 35 before the reception resonant circuit element 36 and the ideal spacing enables the clearest and most accurate isolation of the echo signals to be obtained, and hence location of conductive material.

The magnetoinductive reflectometry apparatus 30 includes a reception circuit 51 that is connected to the reception antenna 50 and generates the reception signal therefrom. The reception circuit 51 includes suitable electronics for generating the reception signal. The reception circuit 51 may be connected to the signal generator 34 to provide accurate triggering of the detection with respect to the input signal.

The magnetoinductive reflectometry apparatus 30 includes an analysis unit 52 that is connected to the reception circuit 51 and is supplied with the reception signal therefrom. The analysis unit 52 performs a post-processing method on the reception signal as will be described below.

When evaluating experimental data, we observe some noise surrounding the signals, due to higher-order coupling and the general presence of white noise. Before any analytical post-processing is undertaken (as discussed below), the experimental setup was configured to reduce the noise through averaging. Due to white noise and natural fluctuations, a single measurement contains significant noise which masks the true shape of the signal. Since the reflection peaks are critical to our detection model, an average over 1024 periods was taken to minimise fluctuations and noise. 1024 was chosen as a trade-off between accuracy and computation time.

The magnetoinductive waveguide 31 is used with at least one idle resonant circuit element 37 at the far end of the magnetoinductive waveguide 31 from the input end. The idle resonant circuit element 37 (or each idle resonant circuit element 37 when there are more than one) is a resonant circuit element 32 that has no conductive material in the vicinity thereof. Accordingly no impedance discontinuity is detected at the (or each) idle resonant circuit element 37. The number of idle resonant circuit elements 37 is chosen to be sufficient to prevent reflection of the injected magnetoinductive waves at the termination of the magnetoinductive waveguide at the far end from obscuring echo signals corresponding to the impedance discontinuity created by conductive material in the vicinity of resonant circuit elements 32.

Idle resonant circuit elements 37 were introduced after observing the theoretical reflection echoes for varying length arrays. It was found that the superposition of the injected and reflected magnetoinductive waves at the far end of the magnetoinductive waveguide 31 causes an anomaly to the expected echo time, but only for a few defect locations. Further investigation found a critical length of the magnetoinductive waveguide 31, where detected reflections remarkably appeared to occur simultaneously for the two defect positions. This meant reflection times were non-unique, and the model would be unable to differentiate between a defect at the penultimate or ante-penultimate position. For our structure's geometry, the critical length was found to be N=30. This is clearly not a prominent issue for a structure of length 20 resonant circuit elements 32, but resonant circuit elements 37 were introduced to eliminate the anomalies due to superposition at the end of the array.

Whilst constructing the analytical model to understand magnetoinductive wave propagation and reflection, it was noted that the reflection from a defect in the penultimate position seems to occur out of line with the trend of the array. For an array of 16 resonant circuit elements 32, when a defect is at resonant circuit element 32 numbered 15, the maximum peak of the echo signal is received by the reception resonant circuit element 36 sooner than expected. We can suggest this is due to superposition at the end of the array causing a shift in the apparent first peak of the echo. FIG. 15a marks the peak of each echo signal for varying defect positions and highlights that a defect on the penultimate resonant circuit element 32 lies significantly off the trendline.

It was found that this shift occurs for all penultimate positions for any length array. The results shown in FIGS. 15a to 15c were derived theoretically and show that a defect on the penultimate position always occurs before the trendline would suggest for any length array. Interestingly, FIGS. 15a to 15c also show that not only does the reflection echo for a defect on the penultimate position arrive sooner, but the echo signal from a defect on the ante-penultimate (i.e., third-to-last) position arrives later. We observe that the times of flight for a reflection off of a defect at locations n-1 and n-2, on a waveguide of n resonant circuit elements 32, move closer together as the array gets longer.

FIG. 16 shows a method of determining a location of conductive material in the vicinity of a magnetoinductive waveguide using the magnetoinductive reflectometry apparatus 30. This method is performed as follows.

In step S1, the magnetoinductive waveguide 31 is excited with the input signal within the form of a pulse, using the signal generator 34. As described above, this causes generation of injected magnetoinductive waves, which are reflected at impedance discontinuities created by conductive material in the vicinity of resonant circuit elements, creating reflected magnetoinductive waves.

In step S2, the reception signal is detected from the reception resonant circuit element 36, using the reception antenna 50 and the reception circuit 51.

In step S3, the detected reception signal is analysed to determine the location of conductive material. Step S3 comprises the method shown in FIG. 17, some steps of which are detailed in FIGS. 20a and 20b. Step S3 is a post-processing method performed in the analysis unit 52.

The analysis unit 52 may be implemented by a computer apparatus. In FIGS. 17, 20a and 20b, the steps of the method are performed in functional blocks of the computer apparatus. The functional blocks process data representing various information described in detail below.

The computer apparatus may implement the method by executing a computer program. In this case, the computer program is capable of execution by the computer apparatus and is configured, on execution, to cause the computer apparatus to perform the method including the steps of the functional blocks. Such a computer apparatus may be any type of computer system but is typically of conventional construction. The computer program may be written in any suitable programming language.

The computer program may be stored on a computer-readable storage medium, which may be of any type, for example: a recording medium which is insertable into a drive of the computing system and which may store information magnetically, optically, or opto-magnetically; a fixed recording medium of the computer system such as a hard drive; or a computer memory.

The method of step S3 shown in FIGS. 17, 20a and 20b will now be described in detail.

The reception signal supplied from the reception circuit 51 is a raw reception signal 60 that is processed by the method. FIG. 18 shows an example of the raw reception signal 60.

The theoretical magnetoinductive waves abide by perfect nearest-neighbour coupling and do not consider natural white noise in the environment. This is a good approximation for the magnetoinductive waveguide 31 shown in FIG. 1, but in practice, the reception antenna 50 will pick up noise and this can mask the echo signal of the reflected magnetoinductive waves. FIG. 18 shows that the raw reception signal 60 is noisy, especially when zooming in on the reflections from defects that are further from the input end. Whilst for these defects we can clearly see the peak of the reflected magnetoinductive waves, if the defect is weak or far away and the noise is of similar magnitude, the accuracy of the model will be significantly hindered. Thus, initially a noise reduction model is applied.

In step S3.1, prior to detection of an echo signal, the raw reception signal 60 is adjusted by subtracting a stored unperturbed signal 61, which corresponds to a reception signal which would be detected from the reception resonant circuit element 36 in the absence of conductive material in the vicinity of the resonant circuit elements 32 of the array. Step S3.1 produces an adjusted reception signal 62. In the absence of an impedance discontinuity, the unperturbed signal appears on the reception resonant circuit element 36 as shown for example in FIG. 8 in element 2. Thus, in the presence of an impedance discontinuity, the unperturbed signal is superimposed on the echo signal within the raw reception signal 60, as shown for example in FIGS. 9a and 9b. In general, it includes components from injected magnetoinductive waves and components from magnetoinductive waves reflected from the end of the magnetoinductive waveguide 31, which may affect the echo signals to different extents, depending on the location of the impedance discontinuities creating the echo signals. However, step S3.1 effectively removes the effects by subtracting the unperturbed signal 61. This allows the echo signal to be isolated and located correctly, with the peak of the echo signal in the correct position.

The unperturbed signal 61 used in step S3.1 may be derived in advance, either by experimental study of the magnetoinductive waveguide 31 or analytically using the theoretical model of the magnetoinductive waveguide 31 described above.

To illustrate this, FIG. 18 shows examples of the raw reception signal 60 for different defect locations and FIG. 19 shows examples of the adjusted reception signal 61 for the same defect locations. The unperturbed signal can be seen in each raw reception signal 60 in FIG. 18 to obscure the echo signals to varying extents, but is removed in the corresponding adjusted reception signals 61 in FIG. 19.

In step S3.2, prior to detection of an echo signal, the adjusted reception signal 62 is filtered to produce a filtered reception signal 63. Optionally the order of steps S3.1 and S3.2 may be reversed.

Step S3.2 is shown in detail in FIG. 20a and comprises two steps as follows.

In step S3.2.1, bandpass filtering of the adjusted reception signal 63 is performed. In practice, the reception antenna 50 detects both the magnetoinductive waves and white noise. Given that the magnetoinductive waves can only propagate through the magnetoinductive waveguide 31 at certain frequencies, it is possible to isolate part of the frequency spectra within the limits of the passband from the magnetoinductive waves from white noise outside the limits of the passband. Thus, the bandpass filtering has a passband corresponding to limits of passband behaviour magnetoinductive waveguide 31. Those limits may be derived from the dispersion relation derived for the magnetoinductive waveguide 31, for example in the manner described above. For example, it is possible to use the same bandpass limits as calculated above (see Eqn. (10), that is fₘᵢₙ=102.3 MHz and fₘₐₓ=116.6 MHz).

To illustrate this we take the echo signal for a defect on element 17 (from FIGS. 18 and 19), and perform the Fast Fourier Transform to reveal the frequencies present, the results before and after bandpass filtering being shown in FIGS. 22a and 22b. The symmetrical frequency spectrum seen in FIG. 22a shows clear peaks at f≈±110 MHz and noise at all frequencies surrounding these sidebands. Applying a bandpass filter isolates the magnetoinductive wave from the noise, FIG. 22b illustrates the resultant signal after filtering, showing effective removal of the noise. Similarly, FIG. 23a shows the time-domain signal before and after filtering, and FIG. 23b shows the power spectral density before and after filtering. This provides visualisation of the relative energies of the frequencies post-processing, where we see only those within the magnetoinductive waveguide bandpass have significant frequency variation strength.

The basis of the defect-localisation model depends on the detectability of the reflectometry echo, and therefore the filtering is a vital step, especially when the noise and reflection pulse are of similar magnitude (for example, when the defect is weak or far away). We see that after filtering the noise has significantly reduced and the sidebands (containing the magnetoinductive wave frequencies) are much more prominent.

In step S3.2.2, envelope smoothing of the reception signal is performed. A smoothing envelope is applied. The smoothing envelope may be optimised in order to provide one significant first maxima in the correct position. The smoothness of the envelope may be adjusted to allow a balance between following the signal tightly for accurate location of the peak and reducing the number of local maxima at the peak. By way of example, FIGS. 24a and 24b give a comparison of the raw experimental reflection signal before and after the noise is removed and the envelope added. We observe much smoother, clearer curves, similar to theoretically generated waves. This will allow the defect localisation model to accurately detect the correct peak in the reflection signal.

The noise-reduction process will be important for experimental data, especially as the defects get weaker and the noise becomes more notable. We can briefly look at what occurs when the theoretical (therefore, no noise) wave is passed through the Noise-Reduction Model. FIG. 25a shows the frequency spectra for a theoretical signal before and after filtering exactly overlap, clearly no noise is present. FIG. 25b supports this, showing the raw and post-processed time-domain signals align exactly and as do the power spectral densities shown in FIG. 25c. Given all frequency components of the analytical magnetoinductive waves lie within the magnetoinductive waveguide bandpass limits, we can summarise that the theoretical waves are unaffected by the filtering step.

The order of steps S3.2.1 and S3.2.2 may be reversed.

Next in the method of FIG. 17, the filtered reception signal 63 is analysed to detect plural locations of conductive material in the vicinity of the magnetoinductive waveguide 31 are detected by detecting the echo signals that correspond to the reflected magnetoinductive waves generated by reflection of the injected magnetoinductive waves at respective impedance discontinuities created by conductive material in different locations. This is done as an iterative process by repetition of steps S3.3 to S3.8, as follows.

In step S3.3, an individual echo signal is detected in the filtered reception signal 63. Thus, repeated iteration of step S3.3 causes the plural echo signals to be detected in turn. In practical terms, on each iteration, the earliest echo signal which forms the first peak in the reception signal may be detected.

Step S3.3 is shown in detail in FIG. 20b and comprises three steps as follows.

In step S3.3.1, an envelope of the filtered reception signal 63 is derived. This may be performed by fitting an envelope function to the filtered reception signal 63. The parameters of the fitting may be adjusted to optimise the fit.

In step S3.3.2, the derived envelope is normalised to its own maximum. This step is optional but improves the accuracy of the process, in particular for relatively weak echo signals.

In step S3.3.3, the first local peak of the normalised envelope is detected. Depending on the implementation, in one approach all local peaks may be detected and then the first of the local peaks is selected. In this step, if a function is used that detects non-zero peaks, then of course such non-zero peaks are rejected as not being a true local peak.

In step S3.3.3, either or both of the following techniques may be applied to correctly identify a peak corresponding to the position of an actual impedance discontinuity. In an analytical model, it is straightforward to identify the correct peak due to the noise-free nature of theory producing smooth and pronounced reflection signals, but of course noise is present in actual measurements. In practice, noise thus masks the signal, meaning that accurate detection of impedance discontinuities is more difficult as the location of resonant circuit element 32 occurs further along the magnetoinductive waveguide 31 and as the conductive material causing the impedance discontinuity gets further away from the resonant circuit element 32. The following techniques improve the accuracy of identifying such peaks.

The first technique is to find peaks in a window that ignores any peaks that occur before the earliest possible arrival time of an echo signal from the next resonant circuit element 32 after the reception resonant circuit element 36. In FIG. 1, the reception resonant circuit element 36 is numbered 2 and the next resonant circuit element 32 is numbered 3. It has been noticed that even after subtraction of the unperturbed signal 61, an artefact occurs early in the signal that could be misinterpreted as a peak, which is avoided by this first technique.

The second technique is for the peak selection only to select peaks that exceed a variable threshold that varies with time and hence location of impedance discontinuities along the magnetoinductive waveguide 31. The selection of this threshold is derived from the recognition that the magnitude of echo signals in the reception signal decreases with increasing time. The variable threshold has been found to substantially improve the automated localisation performance.

The variable threshold is selected so that the peak selection only selects peaks corresponding to echo signals that are of a sufficient magnitude to have been generated by an impedance discontinuity. The variable threshold may be derived by considering timings corresponding to respective resonant circuit elements 32 in turn and selecting the variable threshold at each timing to be below the minimum strength of an echo signal corresponding to a maximum spacing of the conductive material from the respective resonant circuit element 32 that is capable of being identified in the reception signal. This ensures that peaks early in the reception signal are only selected if they have been of sufficient magnitude to correspond to the conductive material and not just spurious fluctuations. The variable threshold is of decreasing value later in the reception signal when minimum strength echo signals are of the magnitude of surrounding noise, and so the variable threshold is set to zero at such later times. FIG. 21 illustrates the shape of the variable threshold in one example.

This approach to derivation allows the variable threshold to be calibrated for any particular magnetoinductive reflectometry apparatus 30.

One way to implement this technique in practice is to reshape the reception signal by subtraction of a reference curve corresponding to the variable threshold, as a preliminary step before peak identification.

Other approaches to detecting an individual echo signal in the filtered reception signal 63 from that shown in FIG. 20b may be applied, for example approaches that detect peaks without explicitly deriving an envelope.

Steps S3.4 to S3.8 are performed between each iterative performance of step S3.3 to detect each successive one of the echo signals.

First, there are described steps S3.4 to S3.6, which are performed in respect of each echo signal that has been detected in the iterative performance of step S3.3.

In step S3.4, the timing of the echo signal peak detected in step S3.3, relative to the timing of the excitation of the feeding resonant circuit element 35, is derived. The timing of the echo signal peak is defined relative to the timing of the excitation of the feeding resonant circuit element 35. This timing corresponds to the time-of-flight of the injected and reflected magnetoinductive waves. In the case of step S3.3 of detecting an individual echo signal in the filtered reception signal 63 being performed as shown in FIG. 20b, then this step may be performed simply by outputting the timing of the first local peak of the normalised envelope detected in step S3.3.3.

In step S3.5, the location of the resonant circuit element at which the impedance discontinuity is created is determined from the timing determined in step S3.4. This is taken as the location of the conductive material. Step S3.5 may be performed by comparing the determined timing with stored timing reference data 64 that relates timing to location.

The timing reference data 64 used in step S3.5 may be derived in advance experimentally by study of the magnetoinductive waveguide 31 or analytically using the theoretical model of the magnetoinductive waveguide 31 described above.

The timing reference data 64 may be presented in any suitable form, for example as a database (look-up table) or by as a recursion.

Thus, repeated iteration of step S3.5 causes the location of each resonant circuit element at which an impedance discontinuity to be detected in turn from the plural echo signals detected in repeated iteration of step S3.3.

In step S3.6, echo signal characteristics of the detected echo signal are determined. Typically, the echo signal characteristics are at least one of amplitude and phase, preferably both.

The amplitude and phase may also be defined as the reflection coefficient, which is a coefficient with real and imaginary parts corresponding to amplitude and phase that are ratios with respect to amplitude and phase of the injected magnetoinductive waves. Reflection coefficients may be defined as functions varying with frequency. In this case, the echo signal characteristics may be amplitude and/or phase of a single frequency component or plural frequency components, or may be a spectrum of amplitude and/or phase across a range of frequency components. However, this adds complication to the derivation and use of the echo signal characteristics, as it becomes necessary to perform a frequency analysis of the detected echo signal.

As an alternative, the echo signal characteristics may be derived from the detected echo signal in the time domain. An example of such an echo signal characteristic is peak reflection coefficient ρ defined, as set out above in the discussion of the theoretical model, as a ratio of the peak amplitude B of the echo signal to the peak amplitude A of the unperturbed reception signal derived from the injected magnetoinductive waves alone.

However, in principle, any characteristics of the detected echo signal could that vary with material characteristics of the conductive material be used.

The characteristics of the detected echo signal are used for two purposes. The first purpose is to allow modification of the filtered reception signal 63 to remove the detected echo signal and will now be described. The second purpose is to derive material characteristics of the conductive material based on the observation that such material characteristics cause corresponding echo signal characteristics of the detected echo signal, as will be described later.

Next, there are described steps S3.7 and S3.8, which have the effect of modifying the filtered reception signal 63 to allow the detection of successive ones of the echo signals in the iterative performance of step S3.3.

In step S3.7, the echo signal 65 previously detected in step S3.3 is derived so that it may be used in step S3.8 to modify the filtered reference signal 63 before the subsequent performance of step S3.3.

In step S3.7, the previously detected echo signal 65 is derived using a stored set of reference echo signals 66. The set contains a reference echo signal 66 in respect of each possible location of a defect, corresponding to the timing of the echo signal detected in step S3.3. Step S3.7 uses the location determined in step S3.5 to select a reference echo signal 66 corresponding to the determined location determined in step S3.5. The most simple approach is for the set of reference echo signals 66 to be indexed by location, so that step S3.7 bases the selection directly on the location determined in step S3.5. However, as the possible locations correspond to possible timings of the echo signals, then an alternative approach is for the set of reference echo signals to be indexed by timing, so that bases the selection on the timing derived in step S3.4.

In general, the echo signal detected in step S3.3 may have variable echo signal characteristics, such as amplitude and phase. Accordingly, in step S3.7, the echo signal characteristics, such as amplitude and phase, of the detected echo signal derived in step S3.6 are also used. In particular, in step S3.7, the previously detected echo signal 65 is derived in accordance with the derived echo signal characteristics, such as amplitude and phase, of the detected echo signal. Two alternative approaches to this as follows.

The first approach is for the set of reference echo signals 66 to include reference echo signals in respect of each possible location of a defect and in respect of different values of the echo signal characteristics, such as amplitude and phase. This requires the set of reference echo signals 66 to be relatively large. The size of the data set may be reduced by increasing the intervals between values of the values of the echo signal characteristics. In this first approach, in step S3.7, it is possible either to select the reference echo signal 66 in the set corresponding most closely to the values of the echo signal characteristics determined in step S3.6 or to interpolate between reference echo signals 66 in the set on the basis of the values of the echo signal characteristics determined in step S3.6.

The second approach is the reference echo signals 66 is for the set of reference echo signals 66 to include a single reference echo signals 66 in respect of each possible location of a defect, and for step S3.7 to select the reference echo signal 66 and then adapt it on the basis of the values of the echo signal characteristics determined in step S3.6, using a predetermined relationship between the form of the echo signal and the echo signal characteristics. The set of reference echo signals 66 used in step S3.7, and the predetermined relationship between the form of the echo signal and the echo signal characteristics, where used in the second approach described above, may be derived in advance, either experimentally by study of the magnetoinductive waveguide 31 or analytically using the theoretical model of the magnetoinductive waveguide 31 described above.

In step S3.8, the filtered reception signal 63 is modified by subtracting the previously detected echo signal 65 derived in step S3.7 from the filtered reception signal 63 to provide a modified reception signal 67.

In subsequent iterations of step S3.3, the modified reception signal 67 is analysed, and in subsequent iterations of step S3.7, the modified reception signal 67 is further modified. As previous echo signals are removed in successive iterative performances of step S3.7, this allows the later echo signals to be detected more easily in step S3.3. In this manner, steps S3.3 to S3.8 are repeated until no further echo signals can be detected, such that all echo signals have been detected.

Given the echo signals arrive at different times, by subtracting a previously detected echo signal due to the first defect it is possible to isolate that echo signal from the later echo signals. Thus, the iterative subtraction method corrects and isolates the location of the subsequent echo signals (removing the decaying sinc waves) and hence significantly improves the overall accuracy of the model. This process can be repeated for the number of defects present.

The subtraction here is similar to the subtraction of the unperturbed signal in step S3.1, but in this case, the previously detected echo signal is removed from the reception signal with plural echo signals, allowing the remaining echo signals to be detected. FIGS. 26a to 26c illustrate an example and show the normalised experimental echoes for a single defect at resonant circuit elements 32 numbered 6, a single defect at resonant circuit elements 32 numbered 10, and two defects at resonant circuit elements 32 numbered 6 and 10, respectively. Calculating their peaks, we find t₆=0.24 μs, t₁₀=0.41 μs, and t_{6,10}=0.24 μs and 0.43 μs, where tᵢ is the experimental magnetoinductive reflection time-of-flight for a defect at element i. We notice that the first peak of t_{6,10} aligns perfectly with t₆ however, the second peak is shifted slightly due to the superposition of the decaying sinc function from the first reflection. Furthermore, we expect this shift to be more significant the closer the two defects are to each other. Subtracting the experimental echo signal from FIG. 26a from the dual echoes in FIG. 26c gives the signal shown in FIG. 26d. Calculating the second peak's time-of-flight, after subtracting out the first peak, now gives t₁₀′=0.41 μs, agreeing with t₁₀ and consequently closer to the theoretical peak. This shows that the correction enables more accurate location of the second defect. This may appear to be a small shift, but it is by no means negligible. Given the timescale we are working at (typical group velocity of 500 km/s, with a typical time-of-flight of approx. 23 ns between resonant circuit elements 32), a shift of 20 ns is significant and requires correction.

FIG. 27 shows a pair of graphs comparing the experimental accuracy of localisation of conductive material as between (a) experimental results derived using the time-domain approach presented herein on the example of the magnetoinductive reflectometry apparatus 30 with the same parameters as used for the experimental results presented herein and (b) frequency-domain localisation in the manner described in Reference (3). These plots are presented for different locations of the conductive material and for different spacings of the conductive material from a resonant circuit element. As shown, the experimental results derived using the time-domain approach achieve error-free localisation up to 2 mm for every resonant circuit element 32, and up to 7 mm for the initial resonant circuit elements numbered 3 to 12. This clearly outperforms the illustrated accuracy of localisation using frequency-domain localisation, and to greater heights of the conductive material.

In step S3.9, material characteristics of the conductive material, to which the detected echo signal corresponds, are determined from the determined echo signal characteristics determined in step S3.6. Step S3.9 may be performed by comparing the determined echo signal characteristics with characteristic reference data 68 that relates the echo signal characteristics to the material characteristics.

The material characteristics may be any characteristics that affect the impedance discontinuity, in particular changing the resonant frequency f₀ and quality factor Q of the resonant circuit element 32, and so affect the echo signal characteristics of the echo signal. Examples of such material characteristics that may be used include any one or more of: a conductivity of the conductive material; a geometrical characteristic of the conductive material; a distance of the conductive material from the resonant circuit element 32 in the vicinity of which it is located; and a lateral position of the conductive material in the direction of propagation of the injected magnetoinductive waves with respect to the resonant circuit element at which the impedance discontinuity is created. Each of these examples affect the impedance discontinuity because they are characteristics of the conductive material which affect the impedance of the resonant circuit element 32 in the vicinity of which the conductive material is located.

In general, the number of material characteristics at most corresponds to the number of echo signal characteristics that are detected, which is two in the case of detecting amplitude and phase. If the number of material characteristics is greater than the number of echo signal characteristics that are detected, then the system is mildly over-defined and so provides additional information which may be used to reduce overall error, noise and uncertainty.

In examples in the case of conductive material that is the conductive body 40, the material characteristics may be distance and lateral position with respect to the resonant circuit element 32 in the case that the size of the conductive body 40 is known, or may be distance from the resonant circuit element 32 and a geometrical characteristic such as size in the case that.

In an example in the case of conductive material that is a part of a continuous object where the geometry is known, such as fluid or inhomogeneity in a lung with known overall geometry (shape of the lung tissue, surrounding muscles, bones, fat), the material characteristics may be the gradient and the mean value of the conductivity of the conductive material, albeit within an approximation of these changes distributed homogeneously or perhaps linearly due to the gravity-induced gradient.

The characteristic reference data 68 may be presented in any suitable form, for example as a database (look-up table) or by a recursion.

The characteristic reference data 68 used in step S3.9 may be derived in advance experimentally by study of the magnetoinductive waveguide 31 or analytically using the theoretical model of the magnetoinductive waveguide 31 described above. In either case, the echo signal characteristics may be determined for all values of the material characteristics in order to build up the characteristic reference data 68.

A first example is to use an approach combining an experimental study and theoretical analysis, by measuring the resonant frequency f₀ and quality factor Q of a single resonant circuit element 32 using a Vector Network Analyser and taking measurements of the conductive body 40 as the material characteristic is changed.

By way of illustration of this first example, FIGS. 27a and 27b show experimentally measured values of resonant frequency f₀ and quality factor Q for varying spacing of the conductive body 40 from a resonant circuit element 32.

The measured resonant frequency f₀ and quality factor Q may then be applied to the theoretical analysis described above to derive a database of time-of-flights for different locations of resonant circuit element 32 and different material characteristics. By way of illustration, FIG. 29 illustrates characteristic reference data 68 determined in accordance with this example in the form of a matrix of the reflection coefficient for a conductive body 40 at different locations and at different spacings from the resonant circuit element 32. The shading in Fig. provides a visualisation of reflection coefficient for different defects at various spacings (from a maximum value of 0.6197 (bottom left) to a minimum of 0.0002 (top right)), which emphasises that both the lateral and vertical positioning of the conductive body 40 affect the strength of the echo signal and hence the location ability.

We observe that even without noise processing the location of the pulse is fairly clear. It gets increasingly difficult to detect the reflection echo as the spacing increases. When the conductive object 40 (a bolt in this example) is about 5 mm above the resonant circuit element 32, the reflections are weak and have a similar amplitude to the noise, making them extremely difficult to isolate. Even as the spacing increases, the techniques disclosed herein allow to detection of every spacing correctly up to 3 mm, and a significant proportion of spacings up to 5 mm. Additionally, our theoretical limit is defined at 5 mm.

The experimental study illustrated in FIGS. 28a and 28b demonstrate the experimental accuracy limit for the techniques described herein as used to determine the spacing of the conductive body 40 from the resonant circuit element 32. From FIGS. 28a and 28b, we observe strong changes in f₀ and Q as the conductive object is close to the resonant circuit element [i.e., axial spacing=0]. As the axial spacing of the conductive material increases, its impact on the resonant circuit element decreases-seen by a smaller change in f₀ and Q for the resonant circuit element, which reduce the impedance discontinuity of the magnetoinductive waveguide. When the conductive material is about 5 mm above the resonant circuit element, the reflection echoes are weak and difficult to detect among natural white noise, as the impedance discontinuity caused by the defect in the vicinity of the resonant circuit element is not strong enough to reflect the injected magnetoinductive wave. Additionally, at this spacing, the conductive material has little effect on the resonant circuit element 32, and hence becomes difficult to detect. Hence, a theoretical limit for this particular arrangement is defined as 5 mm.

This surpasses the sensitivity of the model in the frequency domain disclosed in Reference [3], which detects up to 0.8 mm for analytically-generated magnetoinductive waves. Comparing theoretical limits, Reference [3] reports a change in f₀ of up to 11% and a change in Q of 72%, whereas the analytical model described herein can operate at a 0.5% change in f₀ and a 12% change in Q and experimentally the present techniques are able to fully detect up to a bolt height of 2 mm, which results in a 2% change in f₀ and a 23% change in Q This represents increased sensitivity to changes in impedance, and detection of weaker defects.

In a second example, the determined echo characteristic may be the peak reflection coefficient ρ discussed above. In this case, the determined material characteristic may be a distance of the conductive material from the resonant circuit element in the vicinity of which it is located.

FIG. 30 shows an example of the characteristic reference data 68 that may be used in the second example. This characteristic reference data 68 is derived in respect of the magnetoinductive reflectometry apparatus 30 with the same parameters as used for the experimental results presented herein and wherein the conductive material is a conductive object 40 in the form of a bolt, as discussed above.

In FIG. 30, there is shown the characteristic reference data 68 derived both from the theoretical analysis set out above (shown in solid lines) and from experiment (shown in dashed lines). It is noted that FIG. 30 shows strong quantitative agreement between the theoretical analysis set out above and the experimental data up to spacings z of approximately 5 mm for all locations and to greater spacings for the locations at smaller distances from the feeding resonant circuit element 35, but characterisation becomes more difficult as the spacing and distance increase. Nonetheless, the agreement between analytical and experimental peak reflection coefficients is strong enough to enable accurate characterisation. To illustrate this, FIG. 31 is a plot of the absolute error (in mm) in the determined spacing through direct comparison of the experimental data and the analytical model, for different impedance discontinuity in different resonant circuit elements 32 (referred to as “defect elements” and different spacings (referred to as “heights”).

### REFERENCES

[1] Shamonina et al., “Magneto-inductive waveguide”, Electron. Lett. 38, 371 (2002)
[2] Shamonina et al., “Magnetoinductive waves in one, two, and three dimensions”Journal of Applied Physics 92, 6252 (2002)
[3] Yan et al., “A Metamaterial Position Sensor Based on Magnetoinductive Waves,” in IEEE Open Journal of Antennas and Propagation, vol. 2, pp. 259-268, 2021
[4] Solymar and Shamonina “Waves in Metamaterials”, Oxford University Press, Oxford (2009).

1. A method of determining a location of conductive material in the vicinity of a magnetoinductive waveguide comprising an array of resonant circuit elements that are magnetically coupled together by analysing a reception signal detected from a reception resonant circuit element of the array, the method comprising:
detecting an echo signal within the reception signal, the echo signal corresponding to reflected magnetoinductive waves generated by reflection of injected magnetoinductive waves, injected by excitation of the magnetoinductive waveguide with an input signal in the form of a pulse, at an impedance discontinuity created by conductive material in the vicinity of a resonant circuit element;
determining a timing of the detected echo signal;
determining the location of the resonant circuit element at which the impedance discontinuity is created from the determined timing, as the location of the conductive material.

2. A method according to claim 1, further comprising adjusting the reception signal by subtracting an unperturbed signal, the unperturbed signal corresponding to a reception signal which would be detected from the reception resonant circuit element in the absence of conductive material in the vicinity of the resonant circuit elements of the array, the step of detecting the echo signal comprises detecting the echo signal from the adjusted reception signal.

3. A method according to claim 1, wherein
the method comprises determining plural resonant circuit elements at which the impedance discontinuity is created from the determined timing, as plural locations of the conductive material,
the step of detecting an echo signal comprises:
detecting plural echo signals within the reception signal in turn, the plural echo signals corresponding to reflected magnetoinductive waves generated by reflection of the injected magnetoinductive waves at impedance discontinuities created by conductive material in the vicinity of respective resonant circuit elements; and
between the detection of each successive one of the echo signals, modifying the sensed signal by subtraction of the previously detected echo signal from the reception signal, and
the steps of determining a timing and determining the location of the resonant circuit element at which the impedance discontinuity is created are performed in respect of each detected echo signal.

4. A method according to claim 1, further comprising filtering the reception signal prior to the step of detecting an echo signal within the reception signal.

5. A method according to claim 4, wherein the filtering comprises bandpass filtering the reception signal with a passband corresponding to limits of passband behaviour magnetoinductive waveguide

6. A method according to claim 5, wherein the limits are derived from a dispersion relation derived for the magnetoinductive waveguide.

7. A method according to claim 4, wherein the filtering comprises envelope smoothing of the reception signal.

8. A method according to claim 1, wherein the step of determining the location of the resonant circuit element at which the impedance discontinuity is created is performed by comparing the determined timing with timing reference data that relates timing to location.

9. A method according to claim 1, wherein the method further comprises:
determining echo signal characteristics of a detected echo signal, and
determining material characteristics of the conductive material, to which the detected echo signal corresponds, from the determined echo signal characteristics.

10. A method according to claim 9, wherein the step of determining material characteristics is performed by comparing the determined echo signal characteristics with characteristic reference data that relates the echo signal characteristics to the material characteristics.

11. A method according to claim 9, wherein the echo signal characteristics include at least one of amplitude and phase.

12. A method according to claim 9,
wherein the material characteristics include one or more of:
a conductivity of the conductive material;
a geometrical characteristic of the conductive material;
a distance of the conductive material from the resonant circuit element in the vicinity of which it is located; or
a lateral position of the conductive material in the direction of propagation of the injected magnetoinductive waves with respect to the resonant circuit element at which the impedance discontinuity is created.

13. A method according to claim 1, wherein the detecting an echo signal within the reception signal comprises detecting a peak in the reception signal corresponding to the reception signal.

14. A method according to claim 1, further comprising:
exciting the magnetoinductive waveguide with the input signal in the form of a pulse; and
detecting the reception signal from the reception resonant circuit element of the array.

15. A method according to claim 14, wherein the step of detecting the reception signal is performed by a reception antenna that is spaced from the reception resonant circuit element.

16. A method according to claim 15, wherein the reception antenna is spaced from the reception resonant circuit element by a spacing at which coupling between the reception antenna and resonant circuit elements adjacent to the receiver resonant circuit element is minimised.

17. A method according to claim 14, wherein the array comprises at least one idle resonant circuit element at a far end of the magnetoinductive waveguide from an input end where the magnetoinductive waveguide is excited, wherein the at least one idle resonant circuit element has no conductive material in the vicinity thereof.

18. A method according to claim 17, wherein the at least one idle resonant circuit element comprises a number of idle resonant circuit elements that is sufficient to prevent reflection of the injected magnetoinductive waves at the termination of the magnetoinductive waveguide at the far end from obscuring echo signals corresponding to the impedance discontinuity created by conductive material in the vicinity of a resonant circuit element.

19. A method according to claim 14, wherein the input signal excites at least one feeding resonant circuit element located before the reception resonant circuit element in the direction of propagation of the injected magnetoinductive waves.

20. A method according to claim 14, wherein the input signal is applied by a signal generator arranged within feeding resonant circuit element.

21. A method according to claim 14, wherein the array is a one-dimensional array.

22. A method according to claim 14, wherein the resonant circuit elements comprise coils in a planar configuration.

23. A method according to claim 22, wherein the coils are shaped as split-rings.

24. A computer program capable of execution by a computer apparatus and configured, on execution, to cause the computer apparatus to perform a method according to claim 1.

25. A computer-readable storage medium storing a computer program according to claim 24.

26. A computer apparatus configured to perform a method according to claim 1.
